(19) United States
(12) Patent Application Publication
(10) Pub. No.: US 2025/0224370 A1
(43) Pub. Date: Jul. 10, 2025

(54) CONCEPT AND METHOD FOR LARGE ION POPULATION SPACE CHARGE DRIVEN ION MOBILITY SEPARATIONS

(71) Applicant: Battelle Memorial Institute, Richland, WA (US)

(72) Inventors: Richard D. Smith, Richland, WA (US); Yehia M. Ibrahim, Richland, WA (US); Sandilya V.B. Garimella, Richland, WA (US); Pearl Kwantwi-Barima, Richland, WA (US)

(73) Assignee: Battelle Memorial Institute, Richland, WA (US)

(21) Appl. No.: 18/404,832

(22) Filed: Jan. 4, 2024

(51) Int. Cl. G01N 27/622

(52) U.S. Cl. CPC G01N 27/622

(57) ABSTRACT

Methods include introducing an ion quantity into an ion accumulation region, wherein the ion accumulation region includes an ion wall controllably blocking a movement of the ion quantity past the ion wall, wherein the ion wall is produced by one or more ion wall electrodes of an electrode arrangement, and directing the ion quantity in a direction towards the ion wall to increase a density of the ion quantity adjacent to the ion wall, such that the quantity of ions becomes space charge separated based on mobility along the direction and adjacent to the ion wall. Related apparatus provide space charge driven mobility separations.

### ACKNOWLEDGMENT OF GOVERNMENT SUPPORT

This invention was made with Government support under Contract DE-AC05-76RL01830 awarded by the U.S. Department of Energy. The Government has certain rights in the invention.

### FIELD

The field is ion manipulation, ion analysis, and ion mobility.

### BACKGROUND

Ion mobility spectrometry (IMS) is a technique for separating and identifying ions. IMS can be employed to separate ions of different composition, such as structurally similar compounds such as isomers, and distinguish conformational features of macromolecules. IMS may also be employed to augment mass spectroscopy (MS) in a broad range of applications, including metabolomics, glycomics, and proteomics.

In many existing systems, when performing IMS, a sample containing different ions is introduced into a first end of an enclosed measurement volume or cell containing a carrier gas, also referred to as a buffer gas. In the cell, the ions move from the first end of the cell to a second end of the cell under the influence of an applied electric field. The ions are subsequently detected at the second end of the cell, most typically as an electrical current as a function of their arrival time at the detector. The sample ions in the IMS cell achieve a maximum, constant velocity (i.e., a terminal velocity) arising from the net effects of acceleration due to the applied electric field and deceleration due to collisions with the buffer gas molecules. The terminal velocity of ions within the IMS cell is proportional to their respective mobilities, and is related to ion characteristics such as mass, size, shape, and charge. Ions that differ in one or more of these characteristics will exhibit different mobilities when moving through a given buffer gas under a given electric field and, therefore, different terminal velocities. As a result, each ion species exhibits a characteristic time for travel from the first end of the cell to the second end of the cell. By measuring this characteristic travel time for ions within a sample, the ions may be identified.

Various IMS formats used for chemical and biochemical analysis include constant field drift tube ion mobility spectrometry (DT-IMS), high field asymmetric ion mobility spectrometry (FA-IMS), differential mobility analysis (DMA), and traveling wave ion mobility spectrometry (TW-IMS). These formats vary in the way the electric field is applied to separate the ions within the IMS cell. However, existing IMS devices are often limited in their ability to separate ions (separation power) due to practical limitations on size and complexity of the electrode structures generating the electric fields that separate the ions. IMS devices are also limited in their sensitivity by the number of ions that are injected into the cell for a separation Furthermore, the number of ions that can be injected into the drift cell of the IMS device is generally limited due to space charge constraints (as well as the ion volume size), as the increased ion density tends to adversely affect the IMS resolution and accuracy, such as leading to distortions in detected IMS peaks. The number of ions accumulated or injected is also limited by the volume that they occupy, as a larger volume results in reduced resolution of IMS separations. Thus, a limited number of ions are injected into the cell directly or accumulated in a preceding accumulation cell or volume before being injected into the cell or IMS device for separation. The use of ion mobility for large scale separations is particularly problematic for such reasons and these reasons have largely precluded applications that involve large ion populations, including ‘industrial scale’ ion processing, and surface coating or deposition (and including ‘soft landing’, where particular ion species are selected for low-energy surface deposition).

Accordingly, there exists an ongoing need for systems and methods for ion mobility separations that can be applicable to larger ion populations.

### SUMMARY

Disclosed methods and apparatus produce a space charge driven mobility separation by pushing ions against an ion wall to increase the ion density until space charge causes a mobility separation along the direction of the pushing.

According to an aspect of the disclosed technology methods include introducing an ion quantity into an ion accumulation region, wherein the ion accumulation region includes an ion wall controllably blocking a movement of the ion quantity past the ion wall, wherein the ion wall is produced by one or more ion wall electrodes of an electrode arrangement, and directing the ion quantity in a direction towards the ion wall to increase a density of the ion quantity adjacent to the ion wall, such that the quantity of ions becomes space charge separated based on mobility along the direction and adjacent to the ion wall. Some examples further include directing at least one space charge separated ion or group of ions of the ion quantity from the ion accumulation to a separate ion region coupled to the ion accumulation region. In some examples, the at least one space charge separated ion or group of ions is directed to the separate ion region without directing other ions or groups of ions of the ion quantity to the separate region. In some examples, the at least one space charged separated group of ions is directed to the separate region through the ion wall. In some examples, the at least one space charged separated ion or group of ions is directed to the separate region laterally and not through a position of the ion wall. In some examples, the separate ion region includes an ion mobility spectrometer and/or a mass spectrometer. In some examples, the ion wall is configured to block the movement of the ion quantity past the ion wall by applying a static electrode potential to one or more of the ion wall electrodes. In some examples, the ion wall is configured to only allow the highest mobility ions of the ion quantity past the ion wall by applying a static electrode potential to one or more of the ion wall electrodes. In some examples, the ion wall is configured to allow ions of the ion quantity to move past the ion wall in an order established in the accumulation region by removing or decreasing an electrode potential applied to one or more of the ion wall electrodes. In some examples, the ion wall is configured to allow ions of the ion quantity to move past the ion wall in an order related to their decreasing mobility by sequentially or continually decreasing an electrode potential applied to one or more of the ion wall electrodes. In some examples, the ion wall is configured to allow ions of the ion quantity to sequentially move past the ion wall in an order related to their decreasing mobility by sequentially or continually decreasing an electrode potential applied to one or more of the ion wall electrodes. In some examples, the ion wall is configured to allow ions of the ion quantity to sequentially move past the ion wall in an order related to their decreasing mobility by sequentially or continually decreasing an electrode potential applied to one or more of the ion wall electrodes and to enter an adjacent region containing an ion mobility spectrometer or a mass spectrometer. In some examples, the ion wall is configured to block the movement of the ion quantity past the ion wall, wherein the ion wall is created by applying potentials to a set of electrodes of the ion wall electrodes that results in a traveling wave moving in a second direction that opposes the direction towards the ion wall. In some examples, the ion wall is configured to only allow the highest mobility ions of the ion quantity past the ion wall, wherein the ion wall is created by applying potentials to a set of electrodes of the ion wall electrodes that results in a traveling wave moving in a second direction that opposes the direction towards the ion wall. In some examples, the ion wall is configured to allow ions of the ion quantity to move past the ion wall in the order established in the accumulation region by removing the potentials that result in the traveling wave. In some examples, the ion wall is configured to allow ions of the ion quantity to move past the ion wall in an order related to their decreasing mobility by sequentially or continually decreasing an amplitude of the traveling wave. In some examples, the ion wall is configured to allow ions of the ion quantity to move past the ion wall in an order related to their decreasing mobility by sequentially or continually decreasing an amplitude of the traveling wave, and to enter an adjacent region containing an ion mobility spectrometer or a mass spectrometer. In some examples, the ion wall comprises a moving ion gate. In some examples, the directing the ion quantity in a direction towards the ion wall comprises applying one or more potentials to one or more movement electrodes of the electrode arrangement. In some examples, the ions are directed in the direction towards the ion wall with a DC gradient and/or with a traveling wave. In some examples, the ion accumulation region comprises an ion storage region. In some examples, the directing the ion quantity in the direction comprises moving the ions entering the accumulation region towards the ion wall at least in part by a gas flow in the direction of the ion wall. In some examples, the gas flow is held constant. Some examples further include increasing or varying the gas flow to move ions of decreasing mobility past the ion wall. Some examples further include applying potentials to one or more of the ion wall electrodes that are selected to limit the maximum ion density achieved in the accumulation region. Some examples further include applying drift or traveling wave potentials to one or more of movement electrodes of the electrode arrangement in the accumulation region that are selected to limit a maximum ion density achieved in the accumulation region. In some examples, maximum potentials applied to one or more of the ion wall electrodes are selected to limit a maximum ion density achieved in the accumulation region to reduce or minimize ion activation or ion dissociation. In some examples, maximum potentials applied to one or more of the ion wall electrodes are selected to cause ion activation or dissociation of ions in a highest ion density region near the ion wall. In some examples, maximum potentials applied to one or more of the ion wall electrodes are selected to cause ion activation or dissociation of ions in a highest ion density region near the ion wall.

According to another aspect of the disclosed technology apparatus include an electrode arrangement defining an ion accumulation region configured to receive an ion quantity, wherein the electrode arrangement is configured to define an ion wall of the ion accumulation region that controllably blocks a movement of the ion quantity past the ion wall, wherein the electrode arrangement and/or a gas source are configured to direct the ion quantity in a direction towards the ion wall to increase a density of the ion quantity adjacent to the ion wall, such that the quantity of ions becomes space charge separated based on mobility along the direction and adjacent to the ion wall. In some examples, the electrode arrangement is configured to direct at least one space charge separated ion or group of ions of the ion quantity from the ion accumulation region to a separate ion region coupled to the ion accumulation region. In some examples, the electrode arrangement is configured to direct the at least one space charge separated ions or group of ions to the separate ion region without directing other ions or groups of ions of the ion quantity to the separate region. In some examples, the electrode arrangement is configured to direct the at least one space charged separated group of ions to the separate region through a position of the ion wall. In some examples, the electrode arrangement is configured to direct the at least one space charged separated group of ions to the separate region laterally and not through a position of the ion wall. In some examples, the separate ion region comprises a region of an ion mobility spectrometer and/or a mass spectrometer. In some examples, the electrode arrangement is configured to produce the ion wall to block the movement of the ion quantity past the ion wall by applying a static electrode potential. In some examples, the electrode arrangement is configured to produce the ion wall to block the movement of the ion quantity past the ion wall by applying electrode potentials to a set of electrodes creating a traveling wave. In some examples, the ion wall comprises a moving ion gate. Some examples further include one or more power sources coupled to the electrode arrangement, a controller coupled to the one or more power sources to control the application of electric potentials to the electrodes of the electrode arrangement to produce the ion wall, direct the ions towards the wall, and/or release ions from the ion accumulation region, and an ion source coupled to the ion accumulation region to provide ions to the ion accumulation region. In some examples, the accumulation region comprises a multipole device. In some examples, the accumulation region comprises a multipole device that is segmented allowing creation of a static or traveling wave electric field that moves ions towards the ion wall. In some examples, the accumulation region is a stacked ring ion guide device allowing creation of a static or traveling wave electric field that moves ions towards the ion wall. In some examples, the accumulation region comprises a structure for lossless ion manipulations (SLIM) device allowing creation of a static or traveling wave electric field that moves ions towards the ion wall.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a schematic of an ion apparatus that can provide space charge-based separation of ions.

FIG. 2 is a flowchart of an example method of providing space charge-based separation into different ion mobility groups.

FIG. 3 is a schematic of an ion apparatus that can read-out different ion mobility groups that have been space charge separated.

FIG. 4 is a flowchart of an example method of reading out ion mobility groups that have space charge separated.

FIG. 5 is a schematic of an example IMS system that employs an ion accumulator that can provide ion mobility groups separated based on space charge.

FIG. 6 is a schematic of an example system of trapping ions based on different ion mobilities.

FIG. 7 is a schematic of an example system that can be used to separate ions based on mobility.

FIG. 8 is a plan view schematic of an example electrode arrangement that can be used in some ion mobility separation examples.

FIG. 9 is a plan view schematic of an example electrode arrangement that can be used to provide a static electric field.

FIG. 10 is a schematic of a SLIM system used to perform experiments revealing space charge drive separation.

FIGS. 11A-11D are graphs of arrival time distributions (ATDs) for three peptide precursors.

FIGS. 12A-12D are mass spectra integrated over the range of arrival times for the data shown in FIGS. 11A-11D.

FIGS. 13A-13B are graphs of arrival time distributions for ions accumulated in region B of the schematic shown in FIG. 10 from the ESI of the peptide mixture.

FIGS. 14A-14D are graphs of arrival time distributions on an absolute sale and normalized scale (insets) for Neurotensin (3+) and (2+), m/z 558 and 836, as well as two of its more prominent fragment ions (y¹⁰ m/z 643 and y¹¹ m/z 724; peaks i and f in FIGS. 12A-12D) for different ion accumulation times.

FIGS. 15A-15D are arrival time distributions for accumulation times (A) 49, (B) 163, (C) 326, and (D) 652 ms for Angiotensin II (2+), m/z 523, and three of its fragment ions (b⁵ m/z 647, y⁴ m/z 676, and b⁶ m/z 784).

FIGS. 15E-15H are normalized ATD for an ion accumulation time of 326 ms and additional storage times of (E) 8, (F) 41, (G) 57, and (H) 163 ms for Angiotensin II (2+) and its m/z 784 b⁶ fragment.

### DETAILED DESCRIPTION

### Introduction to Space Charge and Ion Mobility Separations

Disclosed apparatus and techniques involve an ion mobility separation mechanism that takes place in the presence of a significant space charge produced by the presence of a very large ion population and where the ion density at some location approaches the space charge limit (i.e., the approximate maximum feasible due to ion-ion repulsion). This ion space charge exerts a second (and varied due to ion density) electric field that impacts the movement or location of ions that are otherwise moving in an existing electric field. The opposing effects of these two fields results in a separation based on the ions that is different from that observed for smaller ion populations, i.e., rather than all ions collecting in some volume without any significant mobility-based differences, and that can be used in various applications. In many examples, the ion populations are very large. This can allow users to work with and address much larger ion populations than typically available from existing systems performing ion mobility separations. Thus, in some instances, disclosed techniques can be applied to produce ion separations on an industrial scale, i.e., by handling and separating very large populations of ions.

The ion mobility separation mechanism operates based on differences in ion mobility in an electric field where there is an effective opposing field that results from high ion densities (i.e., space charge). Disclosed examples can include various approaches and arrangements for generating such opposing fields. In some examples, a blocking potential forms an effective ‘ion wall’ for ions moving along a linear path that is used to build up a large population of ions and achieve high ion densities. For example, ions can be introduced into a region and gradually move towards this effective ion wall in the presence of an electric field, and a large ion population accumulates near the effective wall as they are driven by that electric field pushing them towards the wall. In some instances, the electric field driving the ions towards the wall can be a traveling wave. In further examples, a constant electric field or ‘drift field’ (such as often used in ion mobility separations) may be used.

In disclosed examples, the separation of large populations of ions can be performed in the gas phase, e.g., with a buffer gas at reduced pressures ranging from <0.1 torr to ˜100 torr and where ions can be effectively trapped or stored. As discussed above, the space charge created by the ions when accumulated in a defined volume (e.g., an ion trap) and achieving high ion densities causes the ions to physically separate according to their mobility. In some disclosed methods, ions are first accumulated in a volume, which can be any type of ion trapping device, such as a RF-field based linear quadrupole ion trap, a stacked ring ion guide, or a Structures for Lossless Ion Manipulations (SLIM). In many instances, the ion accumulation can be concurrent with movement and compaction of ions in the volume (to achieve high ion densities) so as to produce the desired ion mobility separation or ion ‘stratification’ in the trapped ion volume. Ions may be directed into and/or through the volume using various mechanisms, such as from an ion source using an electric field at the reduced pressure of a buffer gas, or may be created in the volume by photo-ionization.

The defined volume can be a trapping volume that confines the ions, e.g., using a combination of electric fields such as the combination of pseudopotentials produced from the application of RF voltages to electrodes and DC fields as used with SLIM. In many method and device examples, the trapping volume can have an extended linear path, with RF confinement on the sides, such as with a multipole (e.g., a quadrupole, octopole, etc.) or a stacked ring ion guide device, or a SLIM ion path, and include DC or RF confinement creating an ion wall at an end opposite the side where ions are injected. In such examples, the injected ions can move through the device along the path toward the end where there can be the DC confinement barrier (which can also correspond to an ion ‘gate’ when the barrier voltage is reduced). A DC confinement barrier can be provided through the application of a DC potential to one or more electrodes. Similarly, an array of electrodes can be used in conjunction with RF of both polarities to create a pseudopotential barrier or wall that can also be varied in location.

The continued introduction of ions of one polarity will cause ions to accumulate in the trapping volume of the device. The ions can be moved toward the gate at the end of the path due to, e.g., a weak field, such as a low drift field, or a low amplitude traveling wave. As a large ion population accumulates, a maximum number of charged species can be reached due to ion-ion repulsion (i.e., the so-called space charge limit) near the end of the device. In other words, the accumulating ion cloud in the gas of the trapping volume can reach a density where the extent of charge-charge repulsion defines and limits the maximum ion density that can be achieved. Charge can then continue to fill the device if still being introduced until the volume becomes filled at close to the maximum ion density. However, such a condition is rarely achieved for larger ion volumes; importantly, before the ion volume is completely filled a large difference in ion density will exist across the volume (from one end to the other of the trapping volume); i.e., the ions of one polarity will have an ion density that is very small at one end and close to the maximum (space charge limited) at the other end (near the wall). The maximum ion density achieved can be minimized, e.g., by selecting an appropriate voltage for the ion wall, and where ions must have both sufficient ion mobility as well as ion density in the region proximal to the wall in order to pass (or ‘go over’) the wall.

In the ion trapping volume, the growing ion cloud density can increasingly distort the electric fields in the volume. While this might be generally understood to be undesirable for most applications, in this environment experiments now show that, surprisingly, some significant separation of ions can occur due to the opposing (e.g., weak traveling wave) electric field and the varying repulsive field of the ion cloud. The ions appear to separate based on their mobility, with the highest mobility ions penetrating deepest into the volume (closest to the ion wall) and its significant space charge (and the region of highest charge density). The ion distribution in the volume can evolve to provide somewhat improved separation with time. For example, ions can actively rearrange, and move into stable distributions, rather than become increasingly mixed due to diffusion as might normally be expected. The trapped large ion population can then be analyzed or manipulated in various ways by changing the electric fields in the volume and thereby “read out” the distribution. For example, information relating to the trapped ions can be provided such as by selectively directing one or more of the space-charge separated ion groups out of the trapping volume to one or more additional instruments (e.g., an ion mobility spectrometer, ion detector, and/or mass spectrometer). In some examples, a traveling wave can be used to produce an “ion surfing” that can cause a read-out of the ions. In other examples, the wall potential can be slowly reduced or scanned to allow ions of decreasing mobility to leave the trapping volume and, e.g., be analyzed.

Thus, disclosed examples can produce a physical separation of ions that occurs due to differences in the mobility of the ions in the gas phase environment. The separations are typically produced using a high ion density and such that the ions create substantial a space charge effect. The separations are of particular interest when involving a very large numbers of ions, such as achieved in SLIM, and that also allows the use of a much larger ion volume than typically utilized. Intentionally creating such an effect stands in contrast to existing ion mobility separation approaches, as such approaches typically seek to avoid space charge effects as they are associated with problems (e.g., distortion of IMS peak shapes, loss of IMS resolution), including degradation of measurement performance. Experiments performed produced the disclosed separation effect using SLIM devices. However, implementations can use an array of electrode-based ion movement and manipulation devices that can produce a high ion density and related space charge stratification according to ion mobility.

As mentioned, space charge is typically viewed as problematic in ion mobility separations as well as other ion manipulations, analyses, and experiments. Generally, more sensitive measurements require more ions, but the presence of additional ions causes performance to degrade due to the distortion of electric fields and/or the physical volume of the ions becoming too large. However, as can be found in various disclosed examples, the accumulation of ions in a SLIM device can be used to improve ion mobility measurements. For example, by accumulating ions in a ‘tight’ band, measurement sensitivity can be increased without degrading performance, particularly the resolving power of the separation. In this way, a large number of ions can be used more effectively.

In various disclosed examples, mechanisms are provided for the prefractionation of ions for subsequent more sensitive analyses. The pre-separation of ions can also result in a higher resolving power separation as the width of the starting ion distribution for a particular species is reduced. This prefractionation (ion separation or stratification) can thus be used to increase the overall dynamic range of various measurements for a given sample size or number of ions. In some examples, such mechanisms can be employed in stand-alone instruments to provide greater sensitivity due to the large ion populations. In further examples, such mechanisms can provide a basis for processing extremely large numbers of ions at atmospheric pressure, and where the product can be separated and recovered.

### Ion Accumulation and Space Charge Separation Examples

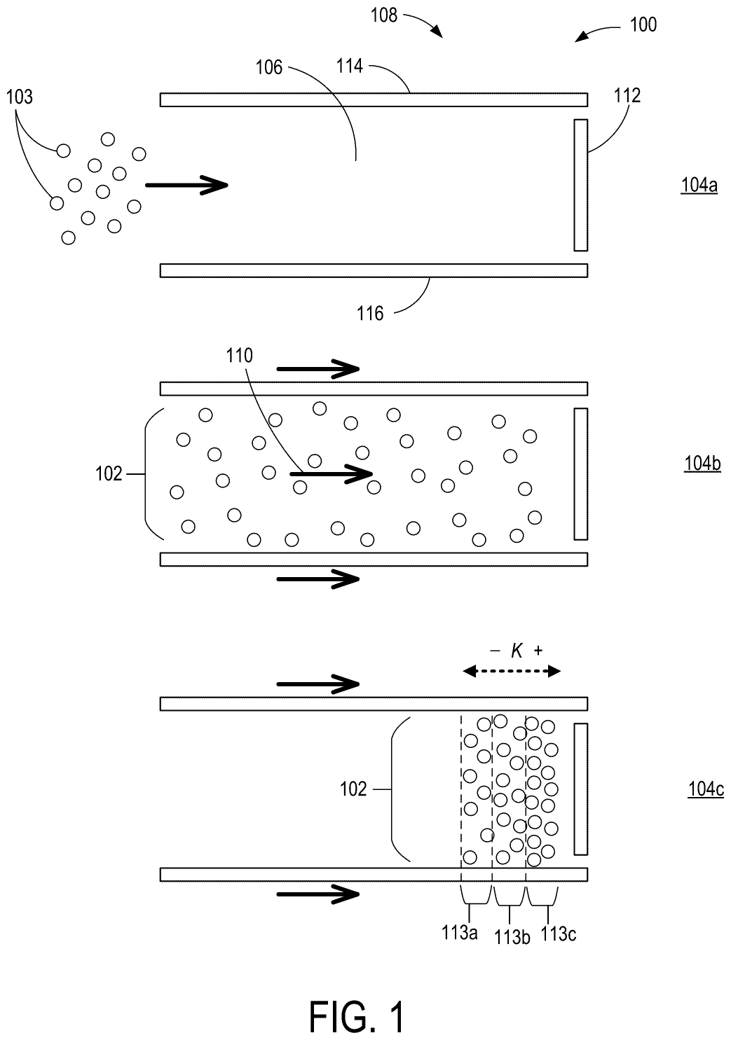

FIG. 1 is an example ion apparatus 100 operating to accumulate and separate an ion quantity 102 based on space charge effects of the ions that occur as the density of the ion quantity 102 is increased in some part of the apparatus ion volume. Shown are three stages 104a, 104b, 104c of operation for the same apparatus 100. At stage 104a, ions 103 of the ion quantity 102 is being injected into an ion accumulation region 106, e.g., from one or more ion sources (e.g., MALDI, ESI, etc.) on the left side. The ion accumulation region 106 typically includes a gas phase component, e.g., a buffer gas at a pressure that allows ion confinement (e.g., typically below about 50 torr for RF-based ion confinement in multipole ion traps or SLIM). In some instances, the gas can be caused to move within the ion accumulation region 106 to augment or replace an electric field though a gas movement is not required. In representative examples, the ion accumulation region 106 is relatively long as compared to ante-chambers or accumulation chambers of existing IMS devices.

The ion apparatus 100 includes an electrode arrangement 108 on device surfaces or boundaries 114, 116 that can also operate to define a spatial extent of the ion accumulation region 106. The electrode arrangement can be coupled to one or more power sources that can apply various electric potentials (typically RF) to the electrodes of the electrode arrangement 108 for ion confinement as well as for creating an electric field within the volume 106. The surfaces or boundaries 114, 116 can support electrode arrangement 108 and can correspond to various materials, such as PCBs. During operation, the electric potentials can initially cause a movement of the ions in a direction 110 towards an effective ion wall 112 of the ion accumulation region 106, as depicted in operational stage 104b. The ion wall 112 typically corresponds to a position (or positions for moving gates) in space within the ion accumulation region 106 where an applied electric field blocks the movement of ions rather than a physical structure. As depicted at stage 104c, with the ion wall 112 blocking or at least significantly slowing the movement of ions in the direction 110, resulting in the density being highest close to the wall and dropping in a continuous fashion with increasing distance from the wall. As the ion density increases and the ions spatially separate by their mobility, with ions closest to the wall having the highest mobility. Groups 113a-113c are separated based on mobility at least in part due to space charge effects that are increasingly present due to the ion density near the wall. The separation can include a positional dependence, with ions closer to the ion wall 112 along direction 110 having a higher mobility than the ions further from the ion wall 112 along direction 110. Thus, in many examples, the electrode arrangement can be used to provide an electric field forming the ion wall to thereby effectively block ions, along with an electric field created by electrodes on surrounding surfaces (of 108) and causing the ions to move towards the ion wall 112 to increase the ion density, while still being insufficient to move beyond or ‘jump the wall’ 112. As shown, the ion wall 112 can correspond to a region of space in which an electric field is produced, or can correspond to one or more of the electrodes of the electrode arrangement 108.

In many examples of the ion apparatus 100, the electrode arrangement 108 can include various electrodes supported on surfaces 114, 116. The electrode arrangement 108 can create auxiliary or additional field contributions and can be formed in various patterns, e.g., spaced apart across the ion accumulation region 106, e.g., as with Structures for Lossless Ion Manipulation (SLIM) electrode sets. In some examples, the electrode arrangement can include electrode sets above and below the plane of FIG. 1, and in additional examples they may be absent. It will be appreciated that the electrode arrangement 108 can be of many different forms and patterns and need not be a SLIM in every example. In some examples, stacked ring ion guides and/or multipole devices can be used. In many examples, the electrode arrangement can include ion wall electrodes that are configured to produce the ion wall 112 and movement electrodes that are used to move the ions towards the ion wall 112. In some examples, ion wall electrodes can be used to perform ion movement and/or movement electrodes can be used to perform ion wall functions, and vice versa. In various examples, the path defining the direction 110 of ion movement can be straight, bent, and/or curved. In some examples, the cross-section of the ion accumulation region 106 is constant along the direction 110 and in other examples the cross-section can include one or more sections that are tapered and/or expanded. The cross-section can also have various forms, which can be constant throughout the ion accumulation region 106 or can vary. Example cross-sections for the ion accumulation region 106 can include square, rectangular, circular, elliptical, etc.

In many examples, the electrode arrangement 108 includes RF electrodes that are used to repel ions from the electrode arrangement 108 and/or other regions so that the ions do not leak out of the ion accumulation region 106. Static guard electrodes (i.e., using DC voltages) may also be used instead or in conjunction with RF electrodes. In some examples, the ion quantity 102 is moved along the direction 110 towards the ion wall 112 with a static DC field gradient, e.g., provided by a monotonic variation of electric potential applied to a series of electrodes along the direction 110. In further examples, the ion quantity 102 is moved along the direction 110 towards the ion wall 112 with a traveling wave. In many examples using traveling waves to urge ions towards the ion wall 112, the amplitude is selected to be relatively low (8 V peak-to-peak in one example). By using a gentler push towards a confinement potential (such as the ion wall 112) the maximum ion density is more limited, which can induce or prevent processes that are affected by ion density, such as ion heating effects that occur only at near the maximum feasible ion density.

In some examples, the ion wall 112 can be provided by a static blocking voltage, e.g., as provided by an electrode or electrodes of the electrode arrangement 108. In further examples, a set of electrodes of the electrode arrangement 108 can be configured to provide a traveling wave along the direction 110 (or in an opposite direction) to form the ion wall 112. In some examples, electrodes proximate the ion wall 112 can be configured to provide a traveling wave, and can be synchronized with a traveling wave provided by electrodes of the electrode arrangement 108 that are configured to move the ions 103 in the direction 110. In some examples, the electrode(s) can include electrodes that provide traveling wave potentials or static DC potentials designed to oppose the field along 110 (e.g., after the traveling wave electrodes, or switching between traveling wave and DC potentials). In other arrangements the ion gate 112 is created using a pseudopotential using an RF field sufficient to confine ions but generally lower than the pseudopotential of 106 used for lateral ion confinement. In this case sampling ions from the volume would involve reducing or removing the RF potentials used to create the gate 112.

In some traveling wave or DC drift field examples applied to the electrodes 114 or 116, the density of the ion population can increase due to space charge itself, i.e., where the ions themselves result in a transient ion gate. For example, ions that are moved by a traveling wave or a DC electric field and that have a sufficient ion current can compress as they move along the direction 110, causing an increase in ion density forming a peak along the direction 110 that moves along the direction 110 more slowly than any of the ions in the absence of space charge. As the local density of ions increases of the peak it acts as an ion wall. In some examples, this wall effect can be increased by changing the characteristics of the traveling wave applied to the electrodes. In some examples, the direction of the traveling wave providing blocking can be in the opposite direction as the direction 110 (i.e., reversed). Thus, by causing the ions to encounter a region with a traveling wave moving more slowly, a significant ion population can form that also produces the ion wall 112.

In various examples, the traveling wave applied to the electrodes on surfaces 114, 116 can correspond to a type of moving gate. For example, ions can be introduced using a traveling wave of some amplitude and the ions then move into a region of lower traveling wave amplitude, and as low as zero. This causes the ions to slow down and accumulate as they enter the different region. As the ion population builds up and the ion density increases, an ion gate is effectively formed based on the repulsive effects of this ion population that is slowly moving primarily due to the slower traveling wave. As the ions continue to build up, the population builds up similar to a static gate or a gate generated by a potential except that the gated population slowly moves in the direction 110. As the population builds, space charge separation can cause an ordering (i.e., separation) of the ions according to mobility.

Thus, in many examples, the ion apparatus 100 can be operable to provide a space charge separation based on mobility by providing a wall at an end (e.g., ion wall 112) of the ion accumulation region 106, e.g., self-generated due to a build-up if an ion population and/or by an applied potential, and by providing a movement force, e.g., a drift field or traveling wave, or a field pushing the ions in the opposite direction. In some examples, the cross-section of the ion accumulation region 106 can be somewhat narrow, e.g., as provided by a SLIM device, which can be used to advantageously increase the resolution of the ion mobility separations that can be achieved. In some examples, use of traveling wave to move ions towards the ion wall 112 and/or to form the ion wall 112 can be used to improve the separation process in some situations. This improvement appears to be based on the oscillation of the ions forward and backward caused by the traveling wave, facilitating ion motion into the different mobility groupings in conjunction with the space charge effects between the ions.

To achieve improved separations in many disclosed examples, it is generally understood that the ion density as well as ion population size are important parameters that significantly impact the separation quality. For example, viewing the process one-dimensionally along the direction of ion movement, the ion wall would be situated at one end near where the large density of the ion quantity 102 is compiled, and the electric field ions experience in the remainder of the device will be determined by the ion density distribution resulting from the application of potentials to a fixed electrode structure that produces the ion wall 112. The applied potentials in 106 resulting from voltages applied to electrodes of the electrode arrangement 108 can be fixed or variable and can have different shapes. However, the self-generating electric field that is formed by the ion quantity 102 due to space charge effects and that produces an ion mobility separation into different species or groups 113a-113c based on mobility, depends on the ion density. In some examples, as the ion density decreases in a continuous fashion with increasing distance from ion wall 112, the amount of the self-generated field and associated separation that can occur can vary. This can cause ions of different mobilities to converge at different positions along the path towards the ion wall 112. In some examples, the reduction in ion density can be configured to occur over a greater distance by changing the fields in 106 using potentials applied to electrodes of the electrode arrangement 108 along the path. In some examples, this can provide the ability to physically separate ions of smaller and smaller mobility difference, which can also be used thereby to achieve higher mobility separation resolution. Some examples can include at least portions of the ion accumulation region 106 that have large cross-sections to increase the size of the ion quantity 102 that is received. In some examples, multiple ion sources can be arranged to increase the quantity of ions that can be injected. Some examples can be relatively large by IMS device standards so that ion quantity can be very large, e.g., with accumulation region volumes from cubic centimeters to meters or larger. In some examples, forces that induce the mobility separation can correspond to a flow of gas and the electric field generated due to the ion-ion repulsion (at the space charge limit). That is, in some instances, the movement of the ions against the ion wall can be produced by the flow of gas alone rather than with electric potentials applied to movement electrodes, or a gas flow in conjunction with an electric field.

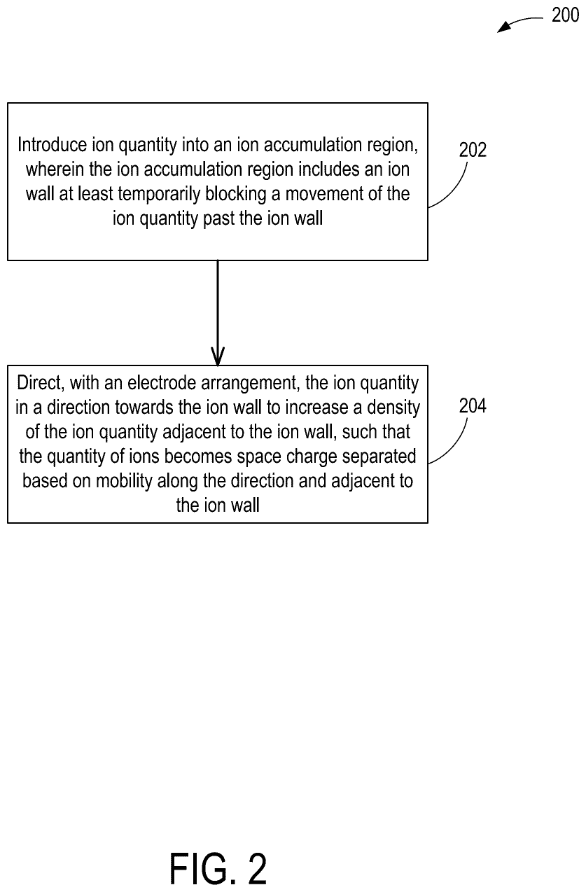

FIG. 2 is an example method of stratifying ions based on mobility. At 202, an ion quantity is introduced into an ion accumulation region of an ion apparatus (such as ion apparatus 100). Example ion apparatus can generally include an electrode arrangement configured to direct the ion quantity along a direction to an ion wall typically produced by selected electrodes of the electrode arrangement. The ion wall at least temporarily blocks further movement of the ion quantity. At 204, the ion quantity is directed (i.e., moved) as a result of the electrode arrangement in the direction towards the ion wall to increase a density of the ion quantity adjacent to the ion wall. The ions continue to be directed at least until the quantity of ions produces a region of high ion density causing a significant space charge effect (due to ion-ion repulsion) on ion mobility along the direction and adjacent to the ion wall. In further examples, both the introduction and direction can occur simultaneously. In ion traps, there is a linear response where the number of ions entering the trap equals the number of ions that exit the trap. Beyond this limit, the trap response is non-linear, and the space-charge phenomenon takes effect.

The ion quantity can be moved towards the ion wall with the electrode arrangement in various ways, e.g., due to a fixed DC gradient and/or due to traveling wave electrodes configured to direct a traveling wave along the direction to the ion wall. The ions can be separated by mobility into individual species or groupings near the ion wall for various timeframes, e.g., on the order of ms, s, minutes, hours, etc., depending on both the size of the ion population and the physical size of the device. Larger ion populations and device sizes generally require longer periods for the separations to develop, and once developed often remain very stable over extended periods. Thus, the ion groupings can be held relatively fixed for various durations for different purposes, such as storage, temporary holding prior to readout, reaction of ions with similar mobilities, etc.

In many examples, after the injection of ions and creation of mobility separations time is not a critical parameter as the stratification of ion population generally becomes fixed in space. Overall, the delineation between separations can be improved with increasing trapping time as the ions becomes better focused or separated. However, separation time per se is different in disclosed examples as compared with ion mobility separations produced in IMS devices, e.g., where a pulse of ions is introduced into a separation volume, the ions separate with an applied electric field, and an arrival time at a detector is carefully observed. In contrast, in disclosed examples, the ions are inserted into the accumulation volume, fields are applied, and the separation occurs, generally reaching a steady state after a sufficient duration (e.g., milliseconds to minutes).

In some instances, increased ion density can be associated with ion heating, which can thereby alter the characteristics of ions and form new ions of different mobility. The new ions can cause the mobility separation to change over time. In some examples, new ions can be formed (by ion dissociation or other reaction such as charge transfer) nearer to the ion wall where the density is higher. During operation new ions or inserted ions can thus be observed to be positioned a considerable distance up-field from the ion wall. Thus, ions can be seen to move against the electric field that is applied to compress the ions and increase density, and this movement occurs due to their space charge and their ion mobility.

### Readout of Space Charge Separated Ions or Groups of Ions

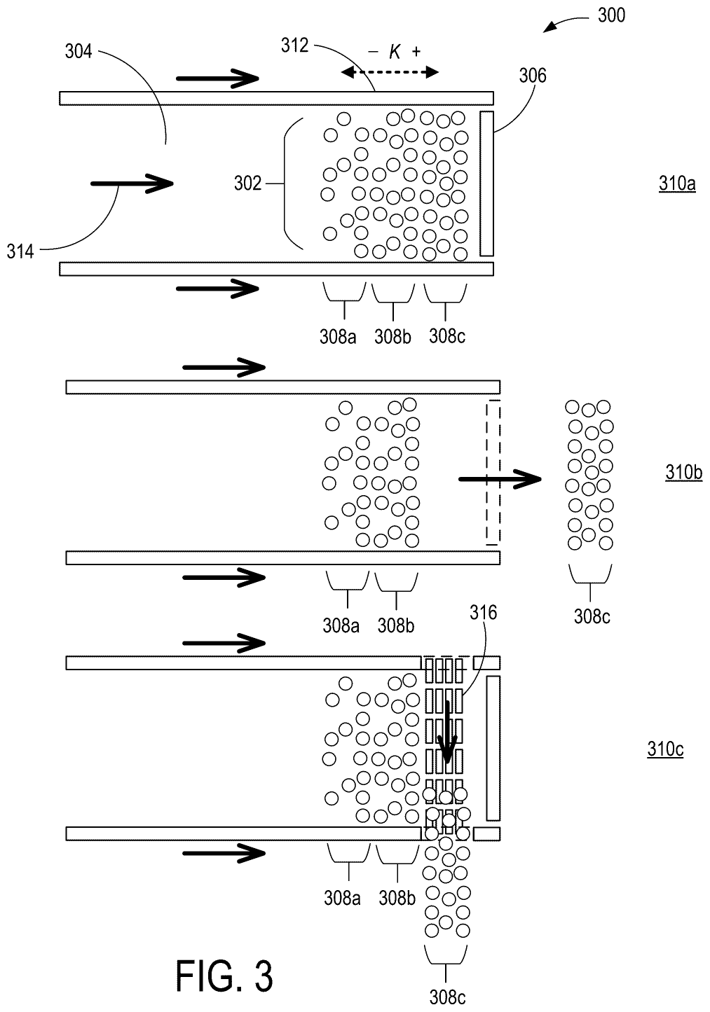

FIG. 3 is an example ion apparatus 300 that can used to produce ion mobility separations. An ion quantity 302 can be injected into an ion accumulation region 304 of the apparatus 300 and the ion quantity 302 can be compressed against an ion wall 306 to increase ion density and produce therefrom ion mobility species separations or separated groupings 308a-308c of ions from the ion quantity 302. As shown at an operation stage 310a, the groupings of ions 308a-308c can be in a relatively fixed position adjacent to the ion wall 306. Groupings 308a-308c are shown to have similar widths in the direction of compression but this is not a requirement. Operational stage 310b shows the effect directing mobility grouping 308c out of the region 304 past the ion wall 306. Operational stage 310c shows the effect of directing mobility grouping 308c out of the region 304 in a different direction from the direction of ion movement and mobility stratification (e.g., perpendicular).

The ion apparatus 300 and its operation can be similar in many ways to or be the same device as any of the apparatus examples described herein, such as examples of apparatus 100 and/or method 200. The ion accumulation region 304 can be defined by an electrode arrangement 312 that can include a plurality of electrodes that can be coupled to one or more power sources. The electrodes of the electrode arrangement 312 can be configured to receive electric potentials that can produce an electric field that can contain the ions of the ion quantity 302 in the region 304 (including to provide the ion wall 306) and also move the ions in a direction 314 towards the ion wall 306 to compress the ion quantity 302. As discussed hereinabove, the ion separations or groupings 308a-308c can form based on a space charge interaction that occurs at high ion densities which are produced by the varying repulsive force generated by the ions with increasing distance from the ion wall 306 and field(s) causing ion movement towards the ion wall 306.

In many examples, after the quantity of ions has been compressed to produce the mobility separation or groupings 308a-308c, all of the mobility separated species or groupings 308a-308c can be released from, or “read-out” of, the region 304 together for e.g., ion measurement or collection. In many examples, this can be achieved by at least changing the potential applied to the ion wall 306. For example, for static DC blocking potentials, the blocking potential can be removed or changed to a non-blocking potential. For example, a static DC blocking potential can be changed to a traveling wave. Alternatively, where the potentials applied by the ion wall 306 to provide ion blocking correspond to traveling wave potentials, characteristics of the traveling wave can be changed (e.g., increasing and/or decreasing the traveling amplitude or speed), or the traveling wave can be removed. In other examples the collected and separated ions from region 304 can be released by slowing reducing the strength of the ion wall 306, and where a slower programmed decrease of the wall voltage can result in improved separation resolution. In some examples, after changing the ion wall potential or potentials, the mobility groupings 308a-308c can be pushed out of the region 304, e.g., past the ion wall 306, by continuing to apply the traveling wave and/or DC gradient to electrodes preceding the ion wall 306 and/or changing its characteristics (e.g., increasing and/or decreasing the gradient, increasing and/or decreasing traveling amplitude or speed, etc.).

As depicted in operational schematics 310b, 310c, various examples of the apparatus 300 can also be configured to selectively read out individual mobility species or specie groupings or ranges of mobility groupings from the region 304. As discussed previously, the ion mobility separations or species groupings 308a-308c can be located along the direction 314. The spacing or extent of separation can be dependent on the injected ions and their mobilities, the applied potential that causes the ions to move towards the ion wall 306, the quantity of the ions 302, and other characteristics of the apparatus 300, such as the area cross-section, volume, and shape.

As shown in operational schematic 310b, characteristics of the electric potentials applied to the electrode arrangement 312 can be configured to allow one or more of the ion mobility separated species or groupings 308a-308c to be moved out of the region 304. For example, as shown, the grouping 308c is moved past the ion wall 306 while the groupings 308a, 308b are retained in the region 304. The selective movement can be provided by controlled application of potentials to the ion wall 306 and/or electrodes of the electrode arrangement 312 preceding the ion wall 306 that cause the ions to move in the direction 314 towards the ion wall 306, similar to as discussed hereinabove. In some examples, a blocking voltage can be switched to a non-blocking potential (e.g., DC or traveling wave) and reapplied after a duration corresponding to removal of the grouping 308c from the region 304 while retaining the groupings 308a, 308b. In some examples, a traveling wave speed applied at the ion wall 306 is switched from a blocking traveling wave speed (which can be the same as a traveling wave speed applied by a preceding set of electrodes of the electrode arrangement 312).

As shown in operational schematic 310c, separately or in addition to the read-out shown in operational schematic 310b, characteristics of the electric potentials applied to the electrode arrangement 312 can be configured to allow one or more of the ion mobility groupings 308a-308c to be moved out of the region 304 along a different direction than along the direction 314 or past the ion wall 306. For example, the mobility grouping 308c can be directed laterally out of the region 304. In some examples, a traveling wave can be used to direct the mobility grouping 308c laterally, e.g., with a separate traveling wave electrode set 316 of the electrode arrangement 312. Another opposing portion of the traveling wave electrode set 316 is hidden for clarity. Alternatively, a DC gradient may be used to direct selected groupings 308a-308c laterally out of the region 304.

In various examples, the amplitude of a traveling wave from the electrodes that is compressing and/or blocking the ions can be increased to freeze their physical location. For example, with the ions separated into the different mobility groupings, the traveling wave amplitude can be increased to freeze their physical location, sometimes referred to as ‘ion surfing’ due to a TW and providing a static isolation of the ion separation or groupings 308a-308c. Change to electrode potentials can then be applied proximate the mobility groupings to move out individual mobility groupings without or with reduced mixing between groupings.

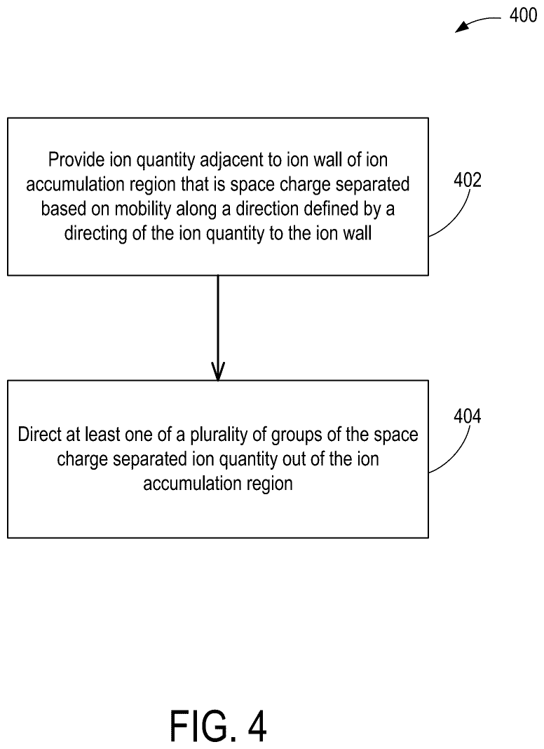

FIG. 4 is an example method of reading out, measuring or collecting ions from an ion accumulation region, with the ions being stratified based on their mobilities. At 402, a quantity of ions is provided adjacent to an ion wall of an ion accumulation region in the presence of, e.g., a uniform voltage or traveling wave, as described above. The ions are space charge separated based on mobility along a direction defined by a directing of the ion quantity and the ion volume size (e.g., 304) to the ion wall. At 404, at least one of a plurality of groups of the space charge separated ion quantity is directed out of the ion accumulation or separation region. In some examples, all of the groups are directed out of or released from the region, and where the release can be either continuously or stepwise resulting from, e.g., the changes to the ion gate potential. In further examples, one or more of the groups is selectively moved out of the region due to, e.g., changes to the ion gate potential, while one or more other ion species or groupings of the ions are retained in the region.

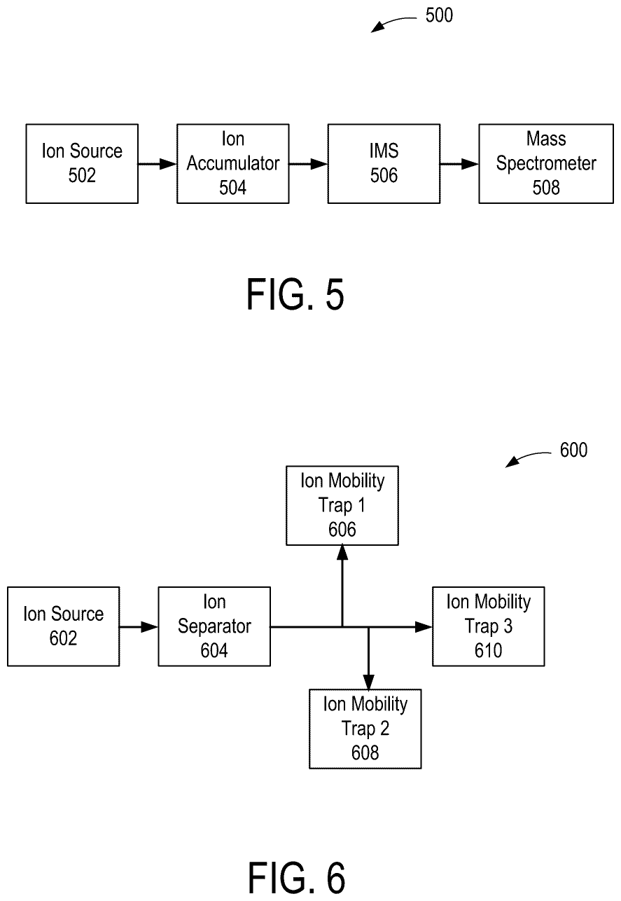

FIG. 5 is an example ion apparatus 500 that can be used for IMS separations and mass analysis. An ion source 502 can be situated to provide ions to an ion accumulator 504. The ion accumulator 504 can be situated to compress the ions received from the ion source 502 and thereby separate (stratify) or pre-separate the ions based on ion mobility along a length of 504. By way of example, the ion accumulator 504 can correspond to any of the other ion apparatus described hereinabove. In some examples, the ion accumulator 504 can be configured to store ions stratified based ion mobility. An IMS 506 can be coupled to the ion accumulator to selectively receive ions from the ion accumulator 504. For example, one or more mobility-based ion groupings stratified in the ion accumulator 504 can be released into the IMS 506 which can proceed to perform an IMS run in which ions are separated based on mobility. With the ion accumulator 504 having prefractionated ions based on mobility, the IMS 506 can provide improved sensitivity for subsequent detections and/or coupling of the IMS separated ions into a mass spectrometer 508 or other mass analyzing device.

FIG. 6 is an example of a space charge ion separator device 600. The ion separation device 600 can include an ion source 602 configured to provide to an ion separator 604. The ion separator can correspond to any of the ion density-based ion accumulation apparatus described hereinabove. The ion separator 604 can be configured to selectively direct accumulated ions that are stratified based on ion mobility to one or more ion volumes or traps 606, 608, 610.

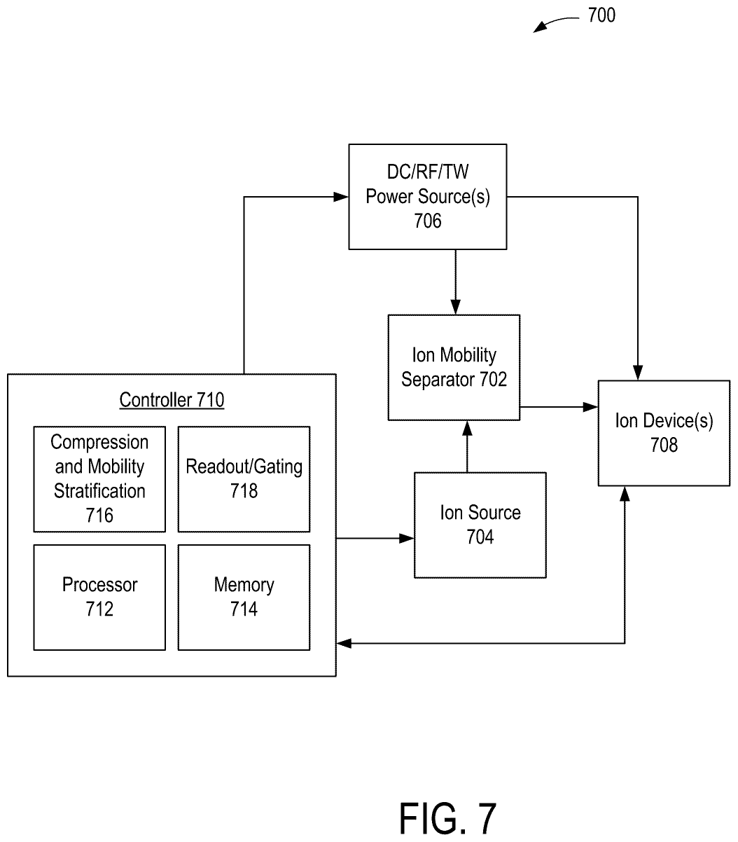

FIG. 7 is an example ion mobility separation system 700. The system 700 includes an ion mobility separator 702 which can include and/or correspond to any of the space charge-based ion mobility separation systems and apparatus described herein (such as apparatus 100, 300, 504, 604). The ion mobility separator 702 can be coupled to an ion source 704 that can direct ions into the ion mobility separator 702. The ion mobility separator 702 typically includes an electrode arrangement that is used to produce compression of the ions directed into it with the ion source 704 by producing an ion wall and moving the ions towards the ion wall. In some examples, the compression of the ions can be produced with a gas flow or with both a gas flow and potentials applied to an electrode arrangement. The ion mobility separator 702 can be coupled to power source(s) 706 to provide various electrical potentials to different electrodes of the electrode arrangement, including RF potentials (typically for repulsion and containment within the ion mobility separator), DC potentials (for containment, movement, and/or blocking/gating), and/or traveling wave potentials (for containment, movement, and/or blocking/gating). The ion mobility separator 702 typically operates at reduced pressures relative to atmospheric as they are typically required for efficient ion confinement. For example, operating pressures are typically less than about 50 torr and typically greater than about 0.1 torr. During operation, after reaching a sufficient ion density from the ion accumulation and compression, the varying space charge repulsion between ions due to the varying ion density can produce a separation or stratification based on ion mobility near the ion wall. The ion mobility separator 702 is often coupled to one or more ion devices 708, which include by way of example, IMS devices, ion conduits, ion funnels, ion detectors, multipole devices, mass spectrometers, and/or ion traps.

The ion mobility separator 702 is coupled to a controller 710 which can be part of a control system environment. Various components of the ion mobility separation system 700 can be coupled to the controller 710, such as the ion source 704, power sources 706, and ion devices 708. For example, the controller 710 can be operable to control ion mobility separation and coupling of separated or stratified ions to the ion devices 708. The controller 710 include one or more computing devices that include at least a processor 712 and memory 714. Computing devices can include desktop or laptop computers, mobile devices, tablets, SCADAs, logic controllers, etc. The processor 712 can include one or more CPUs, GPUs, ASICS, PLCs, FPGAs, PLDs, CPLDs, etc., that can perform various data processing or I/O functions associated with the control system environment. The memory 714 can be volatile or non-volatile (e.g., RAM, ROM, flash, hard drive, optical disk, etc.) and fixed or removable and is coupled to the processor 712. The memory 714 can provide storage capacity for one or more computer-readable media. One or more system buses (not shown) can provide a communication path between various environment components. The control system environment can also be situated in a distributed form so that applications and tasks are performed by remote processing devices that are linked through a communications network. In a distributed computing environment, program modules and logic can be located in both local and remote memory storage devices.

The controller 710 can include compression and ion mobility stratification control logic 716 that can control the selection, timing, and duration of electric potentials applied to the electrodes of the ion mobility separator 702 through controller of the power sources 706 and its mapping to the electrode arrangement. The logic 716 also can control timing of the ion source 704 used to inject ions into the ion mobility separator 702 in relation to the electrode potentials so that ion compression can occur sequentially and/or concurrently with ion injection. The logic 716 can apply electrode potentials to form an ion wall and apply electrode potentials that cause the ions to move towards that ion wall. The resulting increase in ion density can produce space charge effects that cause the ions to then compress and separate (stratify) by ion mobility in the direction the ions are being compressed. In some examples, the ion wall can remain at a fixed location and in other examples the ion wall can define a moving gate. The logic 716 can adjust applied potentials based on an expected range of mobilities that are to be compressed and stratified. For example, adjusting the potentials can be used to adjust a positional dependence (in the direction of compression) of the mobility groupings that become stratified.

The controller 710 can also include readout/gating logic 718 that can be used in connection with the compression and mobility stratification logic 716. For example, the readout/gating logic 718 can be used to release one or more mobility groupings of stratified ions from the ion mobility separator 702, such as to one or more of the ion devices 708, release any set of ions that are not compressed, and/or to purge the separator of other contents. To release one or more groups of ions, the logic 718 can cause a change of electric potentials applied to define the ion wall and/or other electrodes. For example, a blocking voltage can be removed to allow ions to propagate past the wall. A traveling wave defining the ion wall (such as a reverse propagating traveling wave, a traveling wave moving more slowly than a traveling wave causing compression, or a traveling wave having a higher peak-to-peak amplitude) can be removed or changed to have different characteristics that allow movement of the ions. In some examples, the logic 718 can cause changes in the application of electrode potential based on a positional dependence of the ion mobility groupings in the ion mobility separator 702, e.g., to cause selected groupings to read out past the wall or laterally through other ion channels.

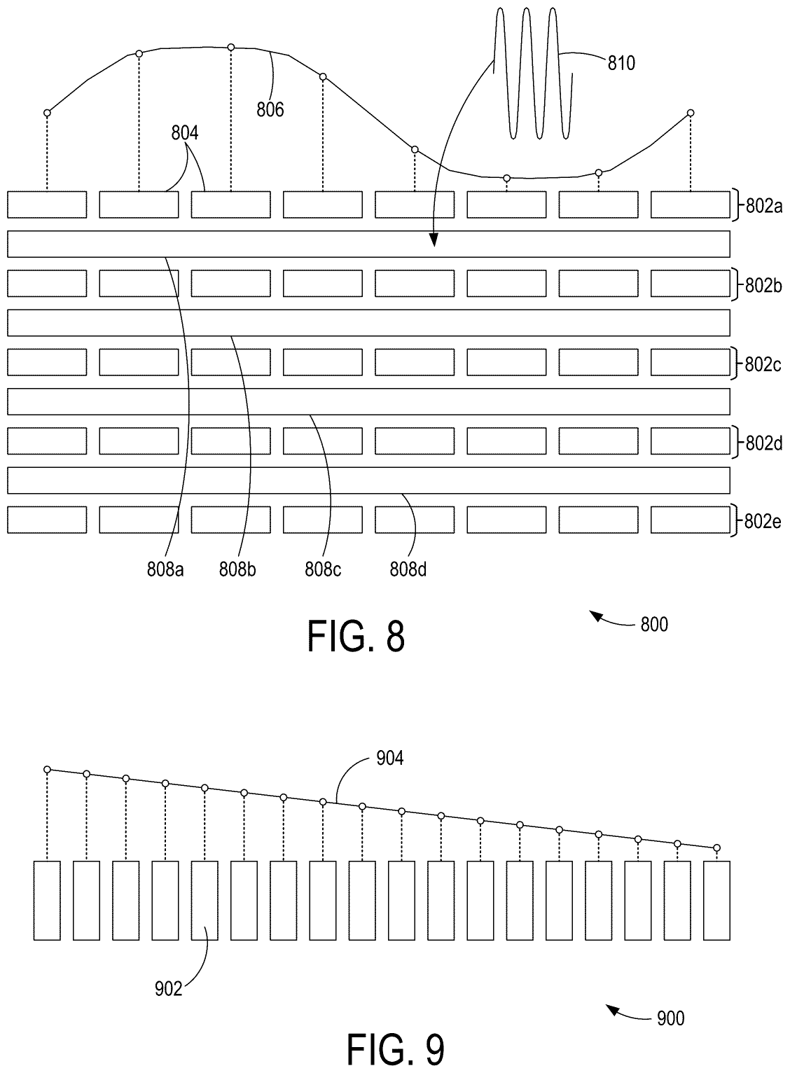

FIG. 8 is an example electrode arrangement 800 that may be used in various electrode-based ion manipulation devices, such as ion apparatus disclosed herein that can be used to compress and stratify ions into mobility groupings. The electrode arrangement 800 can also be used with structures for lossless ion manipulation (SLIM) devices, or other IMS devices. The electrode arrangement 800 can include traveling wave electrode sets 802a-802e, with each set including a series of traveling wave electrodes 804 arranged generally along a path of ion travel (e.g., left to right in FIG. 8). A voltage profile 806 depicts an example traveling wave potential that can be applied to the electrodes 804 at any instant of each set 802a-802e. A plurality of RF electrodes 808a-808d can be interspersed among the electrode sets 802a-802e and configured to receive an RF voltage waveform, e.g., similar to profile 810. Adjacent RF electrodes, such as RF electrodes 808a, 808b or RF electrodes 808c, 808d, are typically 180 degrees out of phase with each other, and every other RF electrode, such as RF electrode 808a, 808c or RF electrode 808b, 808d, are typically in-phase with each other.

FIG. 9 is an example electrode arrangement 900 that may be used in various electrode-based ion manipulation devices, such as ion apparatus disclosed herein that can be used to compress and stratify ions into mobility groupings. The electrode arrangement 900 can also be used in other devices such as drift tubes and stacked ring ion guides. The electrode arrangement can include a series of electrodes 902 (which can be the same or different from each other) that is configured to receive a DC potential gradient, e.g., as shown with linear profile 904. Other profiles may be used, including nonlinear, non-monotonic, etc. Profiles can also provide for blocking or gating potentials, e.g., where a decreasing profile is substantially increased at one or more electrodes.

### EXPERIMENTS

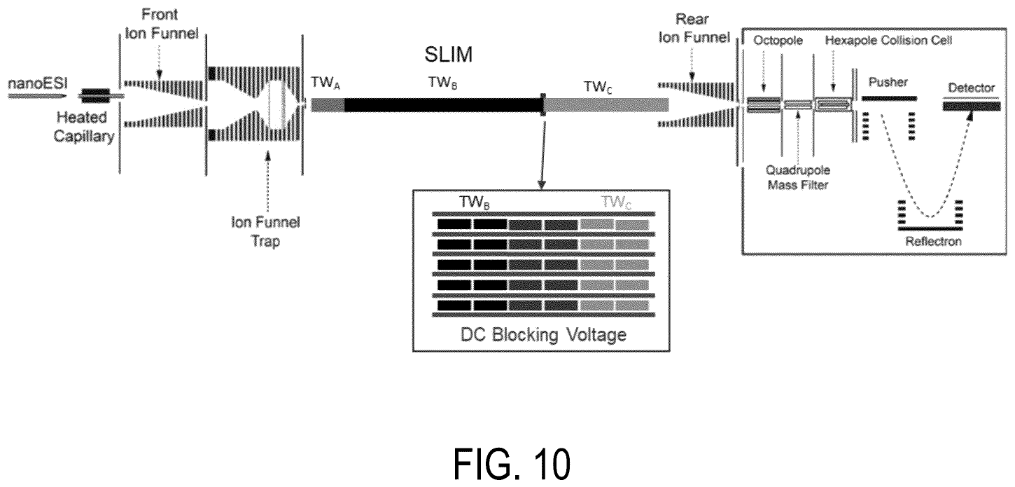

Large populations of peptides Angiotensin II, Kemptide, and Neurotensin were studied. The peptides were prepared as a mixture at a total solution concentration of 3 μM in 80/20 HPLC grade methanol/water with 0.1% formic acid. FIG. 10 shows a schematic diagram of the instrumentation that was used in the experiments. A syringe pump flow rate of 0.3 μL/min was used for ESI with a heated inlet capillary maintained at 130 C. Ions were focused through a high-pressure ion funnel (230 Vp-p, 9.40 Torr) and transmitted into the IFT (˜230 Vp-p, 2.90 Torr). The IFT was only used for transmitting or blocking the transmission of ions to the SLIM, not for trapping ions. Ion introduction to the SLIM was turned “off” or “on” using the IFT grids, and ions were introduced continually from the ion source during the accumulation event period. The ions transmitted to the entrance of the SLIM (at a slightly higher pressure; 2.97 Torr of high-purity nitrogen), where the SLIM TW, RF, and DC potentials guided ions along a linear 45.8 cm path. Ions exiting the SLIM device were transmitted through a rear ion funnel (9.8 V/cm; ˜150 Vp-p; 0.9 MHz) and RF ion guides to a quadrupole time-of-flight mass spectrometer. The DC guard voltage (4 V) and RF potentials (270 Vp-p, 1.0 MHz) were used for ion confinement in the SLIM. The TW electrode potentials were generated with a power supply. It should be noted that ions spend ˜6 ms transiting the rear ion funnel and contributing both a time delay and a small amount of mobility-based separation to the Arrival Time Distributions (ATD). As the system was designed and optimized for peptide mixture analyses, the rear ion funnel has a low m/z cutoff of ˜380. This prevents ions below m/z˜380 that can be transmitted through the SLIM, or accumulated and trapped extended periods in the SLIM, from being detected. Thus, even though ions below ˜m/z 350 were not injected into the SLIM (the estimated m/z cutoff of the front ion funnel), ions of m/z˜200 to 380 that are formed in the SLIM, such as by dissociation, will not be detected. This effective detection “blind spot” is evident (or likely) in several of the experimental results. All experiments were performed in triplicate to assess the reproducibility of the result, and each replicate was a sum of nine individual measurements. The three peptides used in the experiments were selected as a balance between a single compound and a complex mixture and to be sensitive to dissociation so as to provide additional insights into potential ion activation during accumulation.

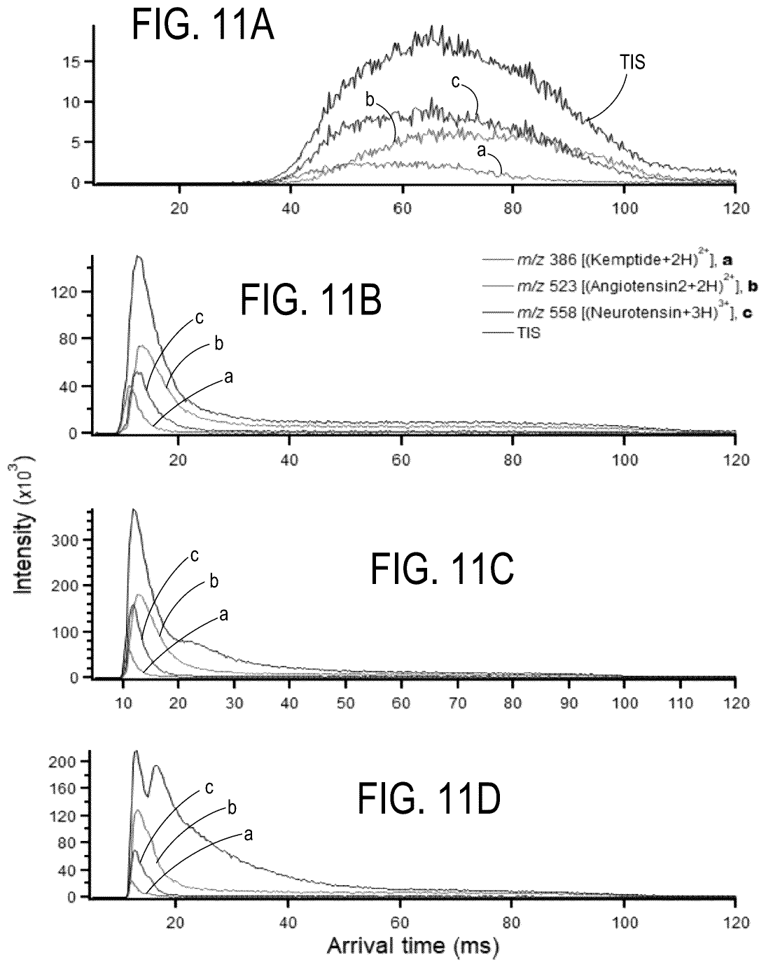

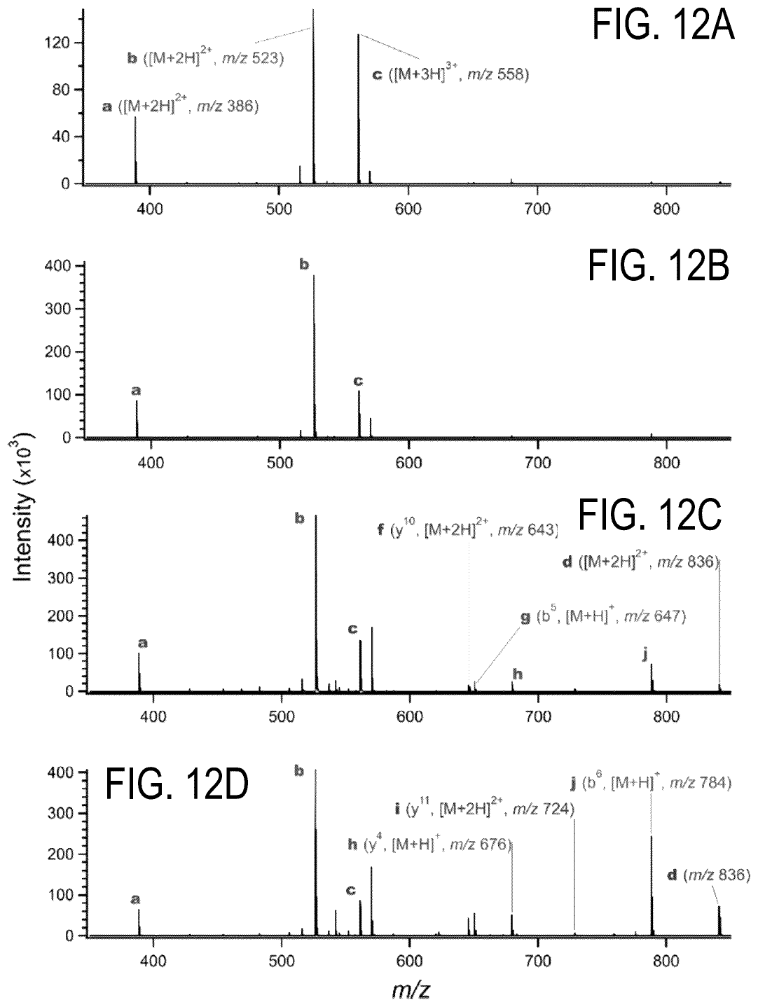

FIG. 10 shows a schematic diagram of a SLIM TWIMS-MS platform along with a SLIM module arrangement that was used in the experiments. The SLIM module arrangement has three independently controllable TW regions. The center electrodes between TWB and TWc indicate the location of the gate that can be provided with a DC ion-blocking potential at the end of region B. The ion funnel trap (IFT) was used to either direct ions from an ESI source into the SLIM or to stop ion accumulation. The SLIM module shown in FIG. 10 was fabricated of FR4 material (woven glass with epoxy). The SLIM module used TW, RF, and guard electrode dimensions similar to those described in the art (e.g., Deng et al., Ultra-High Resolution Ion Mobility Separations Utilizing Traveling Waves in a 13 m Serpentine Path Length Structures for Lossless Ion Manipulations Module. Anal. Chem. 2016, 88 (18), 8957-8964.). The 45.8 cm path of the SLIM module shown in FIG. 10 has three distinct regions (A, B, and C) that used independently controlled TW. The short ion introduction region A (0.9 cm long) used a 5 Vp-p TW amplitude that served to transfer ions to the accumulation region B (30.7 cm long) that used TW of different amplitudes (8, 15, and 20 Vp-p). This region is followed by region C (14.2 cm long), which used a TW amplitude of 30 Vp-p, sufficient to cause ion “surfing”, to maintain the temporal profiles of ion populations exiting region B. The TW speed in all three regions was 160 m/s (i.e., only the TW amplitude of region B was varied in this work). At the end of region B two rows of nominally TW electrodes (FIG. 1, red) with 50 and 80 V applied, respectively, were used for a portion of the time as an ion gate to prevent the passage of ions; the voltage applied to these electrodes could be changed between either a fixed DC voltage (i.e., the gate's blocking voltage) or set to the appropriate TW potentials (for “opening the gate”). This determined whether ions were trapped in region B or transmitted into region C, where they would surf to the SLIM exit (and then be transmitted through the rear ion funnel to the mass spectrometer, with the exception of ions lost due to its low m/z cutoff, as noted above). With reference to FIGS. 11A-D, for the arrival time distributions (ATD), the gate blocking voltage was held constant for an additional 8 ms after the completion of ion accumulation. Specifically, ATDs are shown for the three peptide precursor ions (at m/z 386, 523, and 558; peaks a-c in FIGS. 12A-12D) and the total ion signals (TIS) for ion accumulation times of (A) 49 ms, (B) 163 ms, (C) 326 ms, and (D) 652 ms using 8 Vp-p amplitude TW. Ions in (A) have insufficient time to reach the gate at the end of region B (see FIG. 10); ions in (B)-(D) have peaks due to accumulating close to the gate, with long “tails” yet to reach the gate vicinity.

FIGS. 12A-12D show full mass spectra corresponding to FIGS. 11A-11D. The mass spectra are integrated over the range of arrival times for the data shown in FIGS. 11A-11D for accumulation times of (A) 49, (B) 163 s, (C) 326, and (D) 652 ms using an 8 Vp-p TW amplitude. The three peptide precursor ions (Kemptide (2+), Angiotensin II (2+), and Neurotensin (3+) at m/z 386, 523, and 558 (peaks a, b, and c) are indicated in A, where they dominate the spectrum. (A) 49 and (B) 163 s accumulation times provided efficient ion utilization and conventional spectra, while longer accumulation times result in decreased relative abundances of the three peptide precursor ions and the appearance of additional ion species resulting from their charge loss or fragmentation (e.g., peaks (d)-(j)).

The use of much larger ion populations than typical with IMS were explored by using greatly extended ion accumulation periods. Possible space charge effects can arise due to the size of the ion populations but also the high charge densities achieved in the extended SLIM ion volume due to the opposing fields of the TW and the ion gate (blocking voltage).

The TW conditions used would not result in space charge effects for conventional ion accumulation times and population sizes. For TWIMS the TW amplitude is generally chosen to optimize separations and their Rₚ. Here, the TW amplitudes used during ion accumulation are much smaller than those typically used for separations, causing ions to move relatively slowly through the linear SLIM track while being confined in orthogonal directions. Once ions are accumulated in region B (shown in FIG. 10) in some experiments they were also stored for additional time before removal of the gate. Removal of the gate potential allows ions to enter region C where they “surf” at the speed of the TW (due to its higher amplitude of 30 Vp-p) to the exit of the SLIM and are transferred to the MS. A small amount of mobility separation can occur post-SLIM, primarily in the rear ion funnel; however, this contribution is generally small. Thus, the arrival time distributions (ATD), such as shown in FIGS. 11A-11D, closely mirror the ion distributions in departing region B, providing a basis for exploring the evolution of ion populations during accumulation and the effects of space charge.

The ˜9 ms period delay (after opening the gate) before the detection of ions seen in FIGS. 11A-11D is due to the combined contributions of the time ions spend traversing region C (˜1 ms), the rear ion funnel in a field of 9.8 V/cm (˜6 ms), and the lower pressure regions to the TOF MS (˜1.5 ms). No significant mobility separation can occur in the first and last of these, as the ions surf in region C and the pressure is insufficient after the rear ion funnel. However, a small extent of mobility separation can occur while transiting the rear ion funnel and that can be estimated based upon the known CCS for the ions or DTIMS measurements (see Supporting Information; FIG. S1). This small contribution will be most significant between Kemptide (2+) and Neurotensin (3+) (˜0.5 ms difference), and even smaller (˜0.4 to <0.05 ms difference, depending upon conformers present) between Neurotensin (3+) and Angiotensin II (2+).

The precursor ion ATD shown in FIG. 11A is much different than those in FIGS. 11B-11D. It is evident that this shortest ion accumulation time (49 ms, and the additional 8 ms after the ion injection event ends; 57 ms total) is insufficient for any ions to reach the end of region B before the gate was removed. The widths of the peptide ion ATD shown in FIG. 11A (˜60 ms) are consistent with the ion injection period (49 ms) with some additional broadening due to ion diffusion, mobility differences, and charge-charge repulsive interactions while transiting regions A and B driven by the low 8 Vp-p amplitude TW. The relative peak intensities in the mass spectrum for this shortest accumulation time (FIG. 12A) show the ion population is largely (>90%) due to the three peptide precursor ions, with a few minor peaks due to background and contaminants ions, and with no significant contributions due to fragmentation of the peptides. Similarly, the TIS area shown in FIG. 11A is only slightly larger than the sum of the areas for the three peptide precursor ions.

While not shown here but consistent with previous work, for the shorter accumulation times (including those of FIGS. 11A-11B) the detected relative ion population sizes (i.e., integrated peak areas) were observed to increase approximately linearly with accumulation time. The appearance of the peaks at ˜10 to 20 ms for the three peptide precursor ions in FIGS. 11B-11D is attributed to ions increasingly accumulating adjacent to the blocking voltage of the SLIM gate; i.e., as the TW moves an increasing portion of the ions to near the gate's potential barrier. These three longer accumulation times display somewhat distinctive characteristics.

For the 163 ms accumulation time (FIG. 11B) the total ion population, judged by the integrated TIS, has increased in proportion with accumulation time, and the integrated TIS is only slightly larger than the summed contributions of the peptide precursor ions, as evident in FIG. 11A. Additionally, no significant ion dissociation is evident in FIG. 12B even though a large fraction of the ions have sufficient time to collect near the gate. The data shown in FIGS. 11A-11B and FIGS. 12A-12B using an 8 Vp-p amplitude TW and ion accumulation times of up to 163 ms indicate that ion accumulation in such cases is both efficient (i.e., avoids ion losses) and does not cause significant ion heating.

The TIS continues to increase approximately linearly for the next longest accumulation time (326 ms; FIG. 11C); the TIS is approximately double that of FIG. 11B (which used a 163 ms accumulation time). However, the TIS maximum intensity is more than twice as large, an observation attributed to the additional time allowing a more compact (i.e., greater ion density) distribution to form near the gate. This maximum TIS (˜360×103 on the consistent arbitrary scale used for the measurements in this work) is close to the maximum observed in these studies. This peak maximum is not exceeded regardless of ion accumulation time, and which may be assumed to approximately correspond to the maximum ion density that is feasible due to space charge limitations for the ions studied. Similarly, the individual peptide precursor peaks are somewhat narrower in width, consistent with the somewhat increased fraction of ions accumulated near the gate. Interestingly, the corresponding mass spectrum (FIG. 12C) shows small but significant new contributions due to ions from the reaction or dissociation of the peptide precursor ions. It should be noted that no dissociation products are observed below ˜m/z 380 even though several fragment ions should be formed, e.g., by dissociation of Kemptide (2+), and attributed to the low m/z cutoff of the rear ion funnel for ions exiting the SLIM.

For the longest accumulation time (652 ms), all three peptide precursor ions show significantly decreased populations based upon their peak areas, and the mass spectrum (FIG. 12D) is now dominated by reaction and fragmentation products. Also of note is the relatively increased TIS at longer arrival times. Also, a decreased maximum in the TIS (to ˜220×103) is observed. Rather than an actual decrease in the ion density near the gate for this longest accumulation time, this can be attributed to “unobserved” lower m/z (<380) species formed by fragmentation of ions close to the gate that are not transmitted through the rear ion funnel, and thus not detected.

The ATD in FIGS. 11B-11D show most ions have time to reach the gate region and form profiles with distinct peaks, but also ˜100 ms “tails” attributed to ions that have insufficient time to reach the area near the gate. The tail lengths are limited by the combined length of regions A and B and their lengths correspond to the time required for these ions to migrate to the gate; thus, ˜100 ms. This estimate is also consistent with the failure of ions to reach the gate for the 49 ms ion accumulation period (FIG. 11A). Based upon these observations and the path length (31.8 cm), it can be seen that ions have average translational speeds of only ˜3 m/s in the low amplitude 8 Vp-p 160 m/s TW.

A subtle observation from FIGS. 11B-11D is small but significant differences in both the peak apex arrival times as well as the peak widths for the three peptide precursor ion species; i.e., some separation occurs. This observation applies for both longer accumulation times and extended storage times. The data shown for the peptide precursor ions in FIGS. 11A-11D were acquired under conditions where only minor mobility-based separations can occur post-SLIM, as discussed above. However, the observed distributions may also be partly attributed to separation, as ions move through region B before their arrival at the gate region (see FIG. 11A). These experiments support a third (space charge-related) contribution, and that is manifested in much more dramatic fashion for other ions.

As ions accumulate at the gate (FIGS. 11B-11D) Kemptide (2+), which has the highest mobility of the three peptide precursor ions, forms the peak closest to the gate. The proximity to the gate for Kemptide (2+) persists with longer accumulation times. The peaks for the three precursor ions also narrow somewhat with increased accumulation time, most evident for Angiotensin II (2+) between FIG. 11B and FIG. 11D.

Thus, the three precursor species have somewhat different proximities to the gate on average. Since the “readout” after the gate is opened results in some degree of mixing during the period between gate removal and ions entering region C, the actual separations for these species may be significantly better than indicated by FIGS. 11A-11D. Importantly, the three peptide precursor distributions are arranged according to their mobilities, with the first (closest to the gate; shortest arrival time) and narrowest being for the higher mobility Kemptide (2+), and the last being for the lower mobility Angiotensin II (2+). Also, the relative size of the three precursor ion populations changes, with decreased relative abundance most evident for the higher mobility Kemptide (2+) for longer accumulation times. These observations are also reflected in the mass spectra shown in FIGS. 12A-12D.

The data indicate that the rates of dissociation and ion-molecule reactions for the precursor ions, such as proton transfer to gas phase impurities, are considerably greater for ions closest to the gate for the longer accumulation times and where the highest ion densities are achieved. These observations are discussed further below related to the separations observed for these additional dissociation and ion-molecule reaction product ion species. Based upon the behavior observed using extended ion accumulation events, the effect of additional storage times on the accumulated ion populations was also explored.

In general, it was observed that changes due to extended storage time are less dramatic than for extended accumulation times and that the ion populations can be maintained without significant losses except for the highest mobility species, as most evident for Kemptide (2+). Also observed is some modest narrowing of the peaks and reduction of their integrated TIS intensities with increased storage time, with ion losses being much more prominent for the higher mobility ions (Kemptide2+) than the lower mobility ions (Angiotensin2+). Extended storage times also led to increasing charge reduction of the Neurotensin (3+) ions to the lower charge state (2+).

The gradual loss of the peak tails as the additional storage time allows more ions to approach the gate. However, even for the longest storage time the TIS profile extends to >˜60 ms. The relatively intense tails evident for the longest storage times are not due to insufficient time for ions to reach the gate region. Indeed, these data suggest that these TIS profile “shapes” are primarily dictated by the ion population size and the combined ion accumulation and added storage time, in addition to the TW amplitude “pushing” ions toward the gate.

For most practical applications, the effects due to excessive space charge, such as ion heating, are undesired, and appropriate ion accumulation conditions would include those corresponding to FIG. 11A or FIG. 11B. In cases such as shown in FIG. 11B, significant gains in S/N and IMS Rₚ compared to FIG. 11A would also be expected after accumulation due to the greater peak intensity and decreased peak width for accumulated ions. Even longer accumulation times, as shown in FIG. 11C, can be attractive for some applications due to the greater peptide precursor ion peak intensities and decreased peak widths evident when some extent of ion heating is not problematic. However, longer accumulation times (e.g., 652 ms; FIG. 11D) suffer from both increased fragmentation and decreased peptide precursor ion peak intensities, and the overall efficiency of ion accumulation falls significantly. Most approaches and applications benefit from avoiding such accumulation conditions for the present SLIM design.

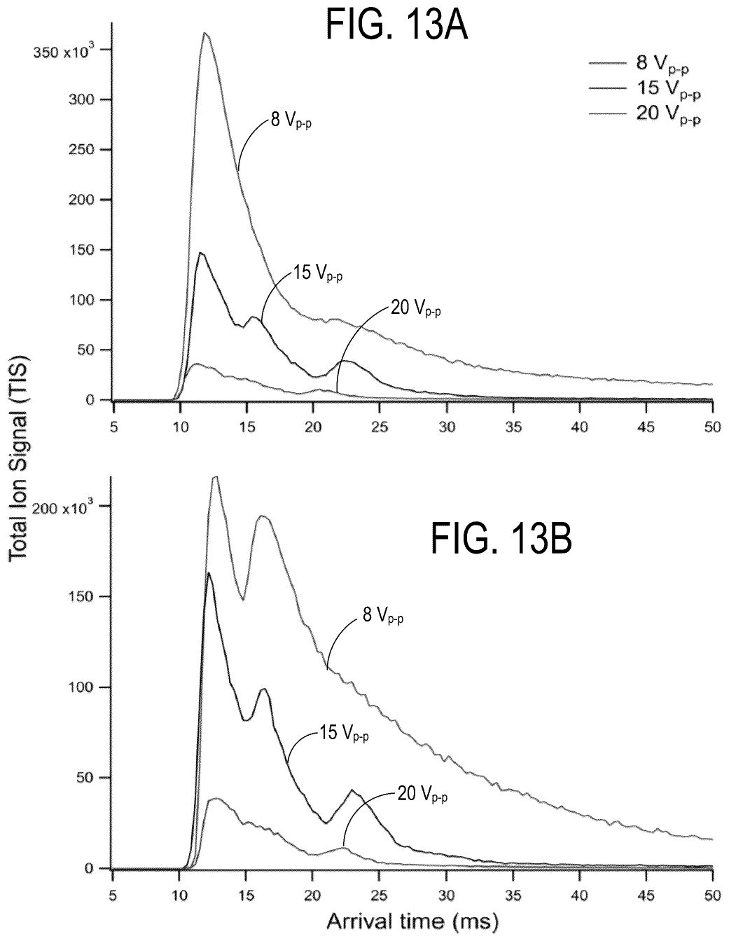

The ion population densities near the gate evident in FIGS. 11B-11D result from the use of a relatively weak 8 Vp-p TW in region B. The trend observed with increased accumulation times is further amplified by the use of higher TW amplitudes that substantially speed up the buildup of ions near the gate. FIGS. 13A-13B shows the TIS for 326 and 652 ms accumulation times for TW amplitudes of 8, 15, and 20 Vp-p. As noted earlier, longer accumulation times using an 8 Vp-p TW amplitude led to a reduced overall efficiency of ion accumulation. The greater TW amplitudes resulted in further significant decreases in the overall efficiency of ion accumulation. The large decreases evident in the TIS amplitude may be at least partly attributed to greater dissociation of the peptides to form fragments that are precluded from detection due to the 380 m/z cutoff of the rear ion funnel and species of lower mobility that are precluded from detection. Consistent also with this is the subtle shift to longer arrival times for the TIS onset with both increased accumulation time and greater TW amplitude, which we can also attribute to increased abundances for lower m/z (higher mobility) fragments also precluded from detection, as discussed earlier.

It is expected that space charge limited ion densities should be rapidly achieved near the gate with the use of higher TW amplitudes, but in fact the large decreases are observed for the maximum TIS. This is likely due to a combination of factors, such as the space charge limited ion density region being made up of lower m/z species that can be trapped in the SLIM but not detected (due to loss to the low m/z cutoff of the rear ion funnel) or this region being too small to be reflected by the measurements (due to an effective averaging over some range of arrival times). Additional studies, both computational (simulations) and experimental, will be necessary to better understand these observations. However, it is also clear that one should avoid the use of higher amplitude TWs, as well as greatly extended accumulation times and ion populations, where space charge limited ion densities are achieved. In the remainder of the experiments, the relatively gentle 8 Vp-p TW was used due to its much greater relevance for practical applications.

For RF-based ion confinement (e.g., using a stacked ring ion guide, multipole ion trap, ion funnel, etc.), there is generally a volume where the likelihood of ion heating due to the RF fields will be negligible and where ions will ideally (for most purposes) reside. Ion excursions into areas where they experience greater RF fields will increase ion translational energies and lead to internal excitation upon collisions, potentially increasing ion losses and fragmentation.

As the overall ion population increases and more ions accumulate near the gate, a peak is formed in the TIS arrival time profile. As the peaks' ion density increases, at some point it is reasonable to expect that the maximum feasible ion density in this region will be limited due to charge-charge repulsion (i.e., space charge), whereupon the ion cloud will expand spatially in some fashion. This expansion can be “backward” along the TW track (leading to longer arrival times), laterally between the DC guard electrodes, or toward the SLIM surfaces and the RF electrodes. Such spatial expansion can lead to ion activation or loss depending on details of the confining potentials (or RF-generated pseudopotentials) in each dimension. Based upon such reasoning, we anticipate that sufficiently low TW amplitudes in trapping/storage volumes would avoid ion cloud expansion in orthogonal directions that cause ion loss or heating effects. In this regard, we have recently demonstrated effective ion accumulation and extended storage after selection from IMS separations using very low TW amplitudes in SLIM trapping regions.

The present data show the ion populations (TIS) shift closer to the gate with increased TW amplitude or time as well as a dramatic effect on the size of the accumulated ion populations. The present data also indicate that ion heating occurs for the densest region of the ion population close to the gate and when the ion density is space-charge-limited in this region. The arrival time distributions in FIG. 2 show Kemptide (2+) to be closest to the gate and have the narrowest distribution. Kemptide (2+) also experiences a significant relative population decrease as accumulation time increases (FIGS. 11B-11D). The longest accumulation times show the “next” precursor peptide ion, Neurotensin (3+), to also show a relative population decrease in conjunction with the appearance of distinctive fragment ions. Thus, these data are consistent with a small fraction of the overall ion population that is near to the gate being selectively subject to significant excitation and dissociation, and this region being sufficiently large to encompass portions of both the Kemptide (2+) and Neurotension (3+) populations.

There is also more definitive evidence for space charge driven separations in view of spatial variation of lower mobility ions formed with extended accumulation times. As discussed hereinabove, the accumulated peptide precursor ions (the distributions shown in FIG. 11A) appear to be “rearranged” to some extent after arrival near the gate. However, while the peptide precursor ion distributions show unexpected and striking behavior for the accumulated and stored ion populations, they nevertheless are relatively subtle effects that also are convoluted with some minor separation in the rear ion funnel.

More striking behavior is observed for other lower mobility ions formed by reactions of the peptide precursor ions. As already noted, the longer accumulation periods result in increasing contributions due to fragmentation or reactions of the peptide precursor ions. As a prominent example, the mass spectra in FIGS. 12A-12D show significant contributions of Neurotensin (2+), m/z 836, only for the longer accumulation times. Consistently, increased Neurotensin (2+) was observed for conditions favoring ion activation: with larger ion populations, longer storage times, and higher TW amplitudes. Neurotensin (2+) likely results from proton-transfer reactions by Neurotensin (3+) (e.g., with gas-phase contaminants) at increased rates upon ion activation. Similar proton transfer processes have also recently been observed for larger numbers of ion trapping events (i.e., accumulation of larger ion populations) and in a SLIM array of traps using a similar ion confinement gate arrangement.

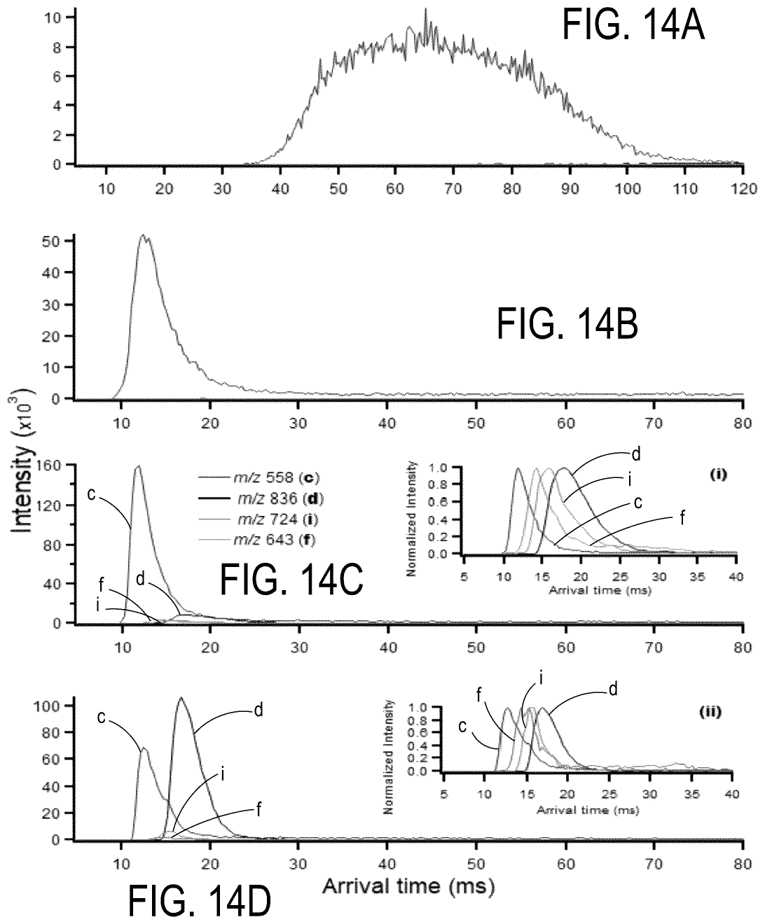

FIGS. 14A-14D show data for the two charge states of Neurotensin (3+ and 2+; m/z 558 and 836) as well as its two prominent fragments (y¹⁰ m/z 643 and y¹¹ m/z 724; peaks i and f in FIG. 12A-12D) for different ion accumulation times. The data are also given on normalized scales for the longest accumulation times (FIGS. 14C-14D insets) to better show the differences in peak arrival times. While Neurotensin (2+) ion population is not significant for the shortest accumulation times (FIGS. 14A-14B), it becomes readily observable for the 326 ms accumulation time (FIG. 14C), but with only ˜10% of the ion population for the 3+ charge state based upon the peak areas. For the longest 652 ms accumulation time (FIG. 14D) the 3+ ions have a significantly smaller peak area than for the shorter accumulation time and the 2+ charge state is greater. It is clear that the 2+ charge state ions are formed in the SLIM from the 3+ charge state. This dramatic change in relative abundance for these species is attributed to reactions in a limited region near the gate where the 3+ ions experience significant space charge related excitation. Thus, the Kemptide (2+) has been sufficiently depleted due to ion heating “to make space” for it in the region of highest ion density, and leading to its activation.

Even more striking than these abundance changes are the different ATD for the two Neurotensin charge states; FIGS. 14A-14D show their arrival time distribution peaks to be mostly resolved. Not only is resolution for the two species observed, but the Neurotensin (2+) is formed largely from previously accumulated Neurotensin (3+) ions near the gate. Thus, Neurotensin (2+) ions have moved in the opposite direction of the TW. Similar trends are evident for the two lower intensity Neurotensin fragment ions shown in FIGS. 14C-14D insets on a normalized scale, with the two fragments forming peaks between the two Neurotensin charge states. This behavior is also observed with increased storage times after accumulation for both the precursor and fragment ions. For a 326 ms accumulation time, with a range of added storage times, both a decrease in the 3+ charge state and an increase in the 2+ charge state with an increased storage time was observed. Again, it appears that upon formation the lower charge state ions move in a direction opposite the TW and contribute to a population much further from the gate than their precursor ions.

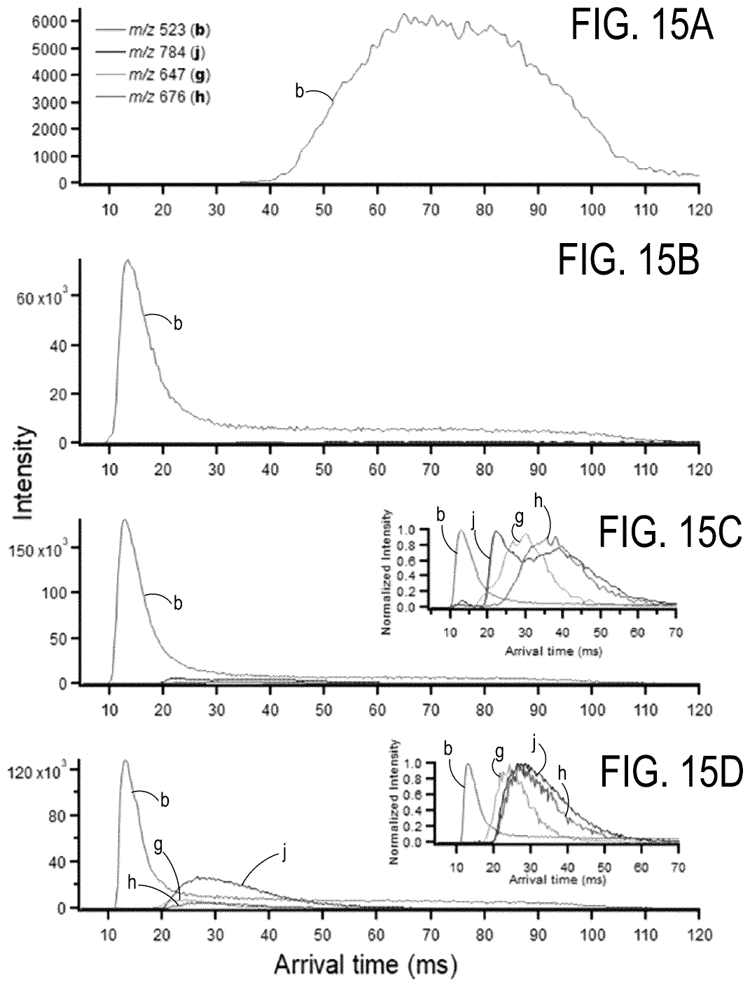

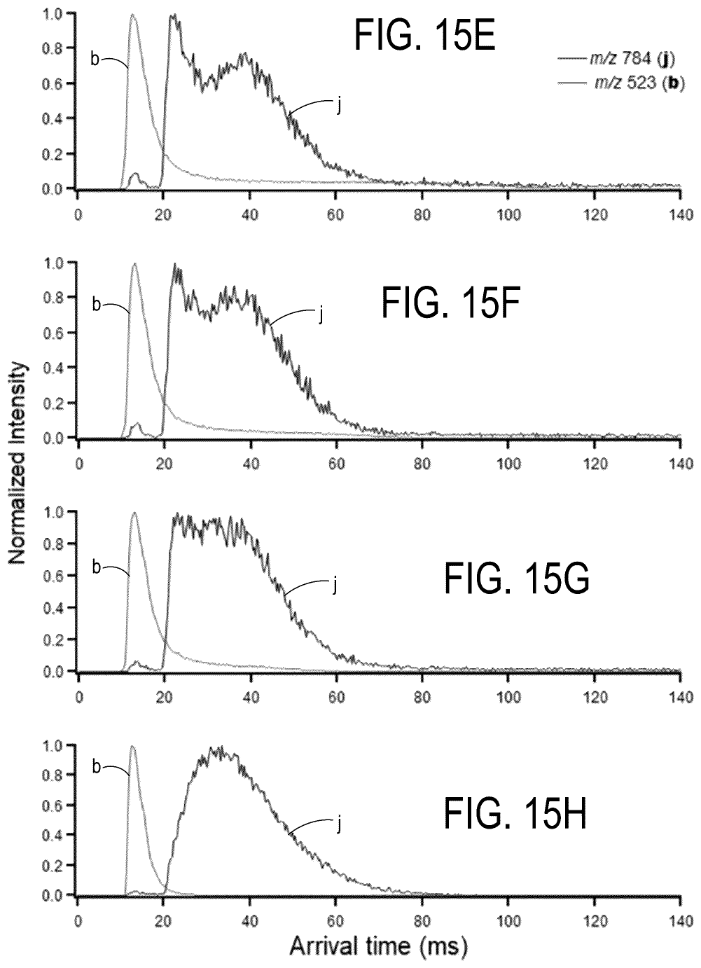

FIGS. 15A-15H show the changes for Angiotensin II (2+) peak intensities for different accumulation times and that are consistent with the above discussion. FIGS. 15A-15D show the arrival time distributions on an absolute scale for Angiotensin II (2+) and the three prominent fragment ions (b⁵ m/z 647, y⁴ m/z 676, and b⁶ m/z 784) and on a normalized scale in FIGS. 15C-15D insets for the different accumulation times. FIGS. 15E-15H show Angiotensin II (2+) and its m/z 784 fragment on normalized scales for the 326 ms ion accumulation time and additional storage times. Consistent with the data for Neurotensin ions, FIGS. 15A-15D show a decrease for the precursor ion population accompanied by an increase in fragment ion populations at longer arrival times. Small contributions can also be seen for the reaction products at the location of the precursor ion near the gate (most evident for the 326 ms accumulation time; see inset to FIG. 15C), i.e., before moving to the peak at longer arrival times.

FIGS. 15E-15H show Angiotensin II (2+) and the b⁶+ fragment (m/z 784) with increasing storage times and where the fragment ion intensity increases significantly during storage. This fragment initially displays a complex profile (see FIG. 15E) immediately following the end of accumulation and with a small but significant component at the same arrival time as Angiotensin II (2+). Thus, this fragment ion apparently arises from Angiotensin II (2+) dissociation near the gate. Consistent with this observation is that the relative magnitude of Angiotensin II (2+) decreases as the later arrival time (m/z 784) distribution increases with increased storage time. This second broad distribution (at ˜25 to 60 ms) is centered at ˜35 ms. The origin of the complex distribution is uncertain, but the component at ˜25 ms appears correlated with the intensity of the short arrival time peak, suggesting it is related to ions “in transit” between the distributions. At least two conformers are observed for Angiotensin II (2+) using DTIMS and multiple conformers have been previously observed by others for both the precursor and fragment ions for Angiotensin II (2+), and the broad fragment ion distribution observed may include such conformers.

These data are again consistent with the activation of ions in a limited volume close to the gate as well as the migration of lower mobility ions formed in this volume against the direction of the TW to form stable peaks detected at later arrival times.

There are numerous implications of space charge driven ion separations. Based upon the above experiments and discussion, it can be concluded that ions are rearranging and focusing to form peaks along the SLIM track volume due to the opposing forces arising from space charge and the TW. The data indicate that the arrival time for a particular species after accumulation and storage (and any subsequent stacking or focusing) depends on the other species present, as long as the ion population is “continuous”, i.e., has no significant gaps in the charge distribution along the track axis. That is, it is expected that trapped ion population density decreases in a distinctive fashion from its maxima near the gate due to the opposing forces of the self-generated space charge and the TWs. The ATD in FIGS. 13A-13D shows that the initial decrease in ion population density along the track axis is steep, and thus better separations might be expected due to differences in space charge that are manifested at shorter arrival times. Similarly, better separations might be expected for lower temperature ion populations, and perhaps using more gentle uniform drift fields rather than low amplitude traveling waves.

Importantly, the use of a lower TW amplitude while accumulating ions is expected to effectively build a population that spreads further from the gate for a given total number of charges and result in broader peaks in the ATD. More ions (e.g., from longer accumulation times) and lower TW amplitudes are thus expected to allow ions to use more of the available volume. Attractive is the use of a TW amplitude that is sufficiently low to enable accumulation of large ion populations with minimal ion heating, and the present experiments show that total accumulation and storage time would also need to be limited. To some extent, the “length” (i.e., the peak or ion population distribution width) can be controlled in a useful fashion by adjusting the accumulation/storage time. Since longer trapping times increase the maximum ion density, a more rapid accumulation of a given population should also result in less ion heating.

The present space charge induced separation findings are new and the conditions under which these phenomena are observed can potentially apply for measurements in other more conventional instrumentation where large trapping volumes and high ion population densities are achieved. This can include linear ion traps, stacked ring ion guides, and ion funnels that are operated in ways generally avoided (e.g., locating a stopping potential at the bottom of an ion funnel having a gentle field gradient).

It must be noted that in the experiments, possible spatial variation for accumulated and stored ions in orthogonal directions (i.e., toward the SLIM surfaces or the side) were implicitly ignored. Previous work for RF multipoles and stacked ring ion guides has indicated some significant spatial variations in ion densities, as well as m/z-based stratification (i.e., separation), can occur, and comparable phenomena may occur here. While this needs to be considered in future computational studies, at present, it is assumed that any such spatial variation does not significantly impact ion population changes at the center of distribution along the SLIM track axis.

Space charge driven ion separations can have a wide ranging set of applications. While these phenomena can benefit from additional experimental and computational study from a fundamental perspective, ion separations under conditions of significant space charge in trapped ion volumes are potentially of significant practical utility. The observed phenomena suggest potentially significant value for ion manipulations, such as ion prefractionation before MS and IMS-MS, for purposes that include improving the sensitivity or dynamic range of analyses. For IMS separations, the narrowing of the starting distribution for one or more constituents in a given volume allows larger ion populations to be used without degrading the resolving power. These separations can potentially be significantly optimized by use of larger ion volumes, such as in extended SLIM track lengths, as well as the use of “cooler” ion populations, optimized fields, etc. One potential type of application that can be envisioned would use two bracketing species to enrich a targeted species (having a specific mobility between the two) to improve the sensitivity of measurements.

### GENERAL CONSIDERATIONS

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Having described and illustrated the principles of the disclosed technology with reference to the illustrated embodiments, it will be recognized that the illustrated embodiments can be modified in arrangement and detail without departing from such principles. For instance, elements of the illustrated embodiments shown in software may be implemented in hardware and vice-versa. Also, the technologies from any example can be combined with the technologies described in any one or more of the other examples. It will be appreciated that procedures and functions such as those described with reference to the illustrated examples can be implemented in a single hardware or software module, or separate modules can be provided. The particular arrangements above are provided for convenient illustration, and other arrangements can be used.

In view of the many possible embodiments to which the principles of the disclosed technology may be applied, it should be recognized that the illustrated embodiments are only representative examples and should not be taken as limiting the scope of the disclosure. Alternatives specifically addressed in these sections are merely exemplary and do not constitute all possible alternatives to the embodiments described herein. For instance, various components of systems described herein may be combined in function and use. We therefore claim all that comes within the scope of the appended claims.

We claim:

1. A method, comprising:
introducing an ion quantity into an ion accumulation region, wherein the ion accumulation region includes an ion wall controllably blocking a movement of the ion quantity past the ion wall, wherein the ion wall is produced by one or more ion wall electrodes of an electrode arrangement; and
directing the ion quantity in a direction towards the ion wall to increase a density of the ion quantity adjacent to the ion wall, such that the quantity of ions becomes space charge separated based on mobility along the direction and adjacent to the ion wall.

2. The method of claim 1, further comprising directing at least one space charge separated ion or group of ions of the ion quantity from the ion accumulation to a separate ion region coupled to the ion accumulation region.

3. The method of claim 2, wherein the at least one space charge separated ion or group of ions is directed to the separate ion region without directing other ions or groups of ions of the ion quantity to the separate region.

4. The method of claim 2, wherein the at least one space charged separated group of ions is directed to the separate region through the ion wall.

5. The method of claim 2, wherein the at least one space charged separated ion or group of ions is directed to the separate region laterally and not through a position of the ion wall.

6. The method of claim 2, wherein the separate ion region includes an ion mobility spectrometer and/or a mass spectrometer.

7. The method of claim 1, wherein the ion wall is configured to block the movement of the ion quantity past the ion wall by applying a static electrode potential to one or more of the ion wall electrodes.

8. The method of claim 1, wherein the ion wall is configured to only allow the highest mobility ions of the ion quantity past the ion wall by applying a static electrode potential to one or more of the ion wall electrodes.

9. The method of claim 1, wherein the ion wall is configured to allow ions of the ion quantity to move past the ion wall in an order established in the accumulation region by removing or decreasing an electrode potential applied to one or more of the ion wall electrodes.

10. The method of claim 1, wherein the ion wall is configured to allow ions of the ion quantity to move past the ion wall in an order related to their decreasing mobility by sequentially or continually decreasing an electrode potential applied to one or more of the ion wall electrodes.

11. The method of claim 9, wherein the ion wall is configured to allow ions of the ion quantity to sequentially move past the ion wall in an order related to their decreasing mobility by sequentially or continually decreasing an electrode potential applied to one or more of the ion wall electrodes.

12. The method of claim 9, wherein the ion wall is configured to allow ions of the ion quantity to sequentially move past the ion wall in an order related to their decreasing mobility by sequentially or continually decreasing an electrode potential applied to one or more of the ion wall electrodes and to enter an adjacent region containing an ion mobility spectrometer or a mass spectrometer.

13. The method of claim 1, wherein the ion wall is configured to block the movement of the ion quantity past the ion wall, wherein the ion wall is created by applying potentials to a set of electrodes of the ion wall electrodes that results in a traveling wave moving in a second direction that opposes the direction towards the ion wall.

14. The method of claim 1, wherein the ion wall is configured to only allow the highest mobility ions of the ion quantity past the ion wall, wherein the ion wall is created by applying potentials to a set of electrodes of the ion wall electrodes that results in a traveling wave moving in a second direction that opposes the direction towards the ion wall.

15. The method of claim 13, wherein the ion wall is configured to allow ions of the ion quantity to move past the ion wall in the order established in the accumulation region by removing the potentials that result in the traveling wave.

16. The method of claim 13, wherein the ion wall is configured to allow ions of the ion quantity to move past the ion wall in an order related to their decreasing mobility by sequentially or continually decreasing an amplitude of the traveling wave.

17. The method of claim 13, wherein the ion wall is configured to allow ions of the ion quantity to move past the ion wall in an order related to their decreasing mobility by sequentially or continually decreasing an amplitude of the traveling wave, and to enter an adjacent region containing an ion mobility spectrometer or a mass spectrometer.

18. The method of claim 1, wherein the ion wall comprises a moving ion gate.

19. The method of claim 1, wherein the directing the ion quantity in a direction towards the ion wall comprises applying one or more potentials to one or more movement electrodes of the electrode arrangement.

20. The method of claim 19, wherein the ions are directed in the direction towards the ion wall with a DC gradient and/or with a traveling wave.

21. The method of claim 1, wherein the ion accumulation region comprises an ion storage region.

22. The method of claim 1, wherein the directing the ion quantity in the direction comprises moving the ions entering the accumulation region towards the ion wall at least in part by a gas flow in the direction of the ion wall.

23. The method of claim 22, wherein the gas flow is held constant.

24. The method of claim 22, further comprising increasing or varying the gas flow to move ions of decreasing mobility past the ion wall.

25. The method of claim 1, further comprising applying potentials to one or more of the ion wall electrodes that are selected to limit the maximum ion density achieved in the accumulation region.

26. The method of claim 1, further comprising applying drift or traveling wave potentials to one or more of movement electrodes of the electrode arrangement in the accumulation region that are selected to limit a maximum ion density achieved in the accumulation region.

27. The method of claim 26, wherein maximum potentials applied to one or more of the ion wall electrodes are selected to limit a maximum ion density achieved in the accumulation region to reduce or minimize ion activation or ion dissociation.

28. The method of claim 1, wherein maximum potentials applied to one or more of the ion wall electrodes are selected to cause ion activation or dissociation of ions in a highest ion density region near the ion wall.

29. The method of claim 1, wherein maximum potentials applied to one or more of the ion wall electrodes are selected to cause ion activation or dissociation of ions in a highest ion density region near the ion wall.

30. An apparatus, comprising:
an electrode arrangement defining an ion accumulation region configured to receive an ion quantity, wherein the electrode arrangement is configured to define an ion wall of the ion accumulation region that controllably blocks a movement of the ion quantity past the ion wall;
wherein the electrode arrangement and/or a gas source are configured to direct the ion quantity in a direction towards the ion wall to increase a density of the ion quantity adjacent to the ion wall, such that the quantity of ions becomes space charge separated based on mobility along the direction and adjacent to the ion wall.

31. The apparatus of claim 30, wherein the electrode arrangement is configured to direct at least one space charge separated ion or group of ions of the ion quantity from the ion accumulation region to a separate ion region coupled to the ion accumulation region.

32. The apparatus of claim 31, wherein the electrode arrangement is configured to direct the at least one space charge separated ions or group of ions to the separate ion region without directing other ions or groups of ions of the ion quantity to the separate region.

33. The apparatus of claim 31, wherein the electrode arrangement is configured to direct the at least one space charged separated group of ions to the separate region through a position of the ion wall.

34. The apparatus of claim 31, wherein the electrode arrangement is configured to direct the at least one space charged separated group of ions to the separate region laterally and not through a position of the ion wall.

35. The apparatus of claim 31, wherein the separate ion region comprises an region of an ion mobility spectrometer and/or a mass spectrometer.

36. The apparatus of claim 30, wherein the electrode arrangement is configured to produce the ion wall to block the movement of the ion quantity past the ion wall by applying a static electrode potential.

37. The apparatus of claim 30, wherein the electrode arrangement is configured to produce the ion wall to block the movement of the ion quantity past the ion wall by applying electrode potentials to a set of electrodes creating a traveling wave.

38. The apparatus of claim 37, wherein the ion wall comprises a moving ion gate.

39. The apparatus of claim 30, further comprising:
one or more power sources coupled to the electrode arrangement;
a controller coupled to the one or more power sources to control the application of electric potentials to the electrodes of the electrode arrangement to produce the ion wall, direct the ions towards the wall, and/or release ions from the ion accumulation region; and
an ion source coupled to the ion accumulation region to provide ions to the ion accumulation region.

40. The apparatus of claim 30, wherein the accumulation region comprises a multipole device.

41. The apparatus of claim 30, wherein the accumulation region comprises a multipole device that is segmented allowing creation of a static or traveling wave electric field that moves ions towards the ion wall.

42. The apparatus of claim 30, wherein the accumulation region is a stacked ring ion guide device allowing creation of a static or traveling wave electric field that moves ions towards the ion wall.

43. The apparatus of claim 30, where the accumulation region comprises a structure for lossless ion manipulations (SLIM) device allowing creation of a static or traveling wave electric field that moves ions towards the ion wall.
